(19) United States
(12) Patent Application Publication
(10) Pub. No.: US 2013/0090222 A1
(43) Pub. Date: Apr. 11, 2013

(54) APPARATUS AND METHODS FOR FOLDING PAPER BOXES

(71) Applicant: INTERNATIONAL PAPER COMPANY, Memphis, TN (US)

(72) Inventor: Jeremy Peter Green, Ladera Ranch, CA (US)

(73) Assignee: INTERNATIONAL PAPER COMPANY, MEMPHIS, TN (US)

(21) Appl. No.: 13/660,618

(22) Filed: Oct. 25, 2012

Related U.S. Application Data
(63) Continuation-in-part of application No. 13/270,354, filed on Oct. 11, 2011.

(51) Int. Cl. B31B 1/26

(52) U.S. Cl. 493/162

(57) ABSTRACT

An apparatus for folding box blanks into completed boxes includes a feeding station having a swing guide assembly designed to provide an abutting surface which makes contact with flaps/panels of the box blank as the box blank is feed from the feeding station into a folding station. The swing guide assembly can be synchronized with a feed assembly which moves box blanks from a hopper assembly to a first feed position. Actuating drives operating at different speeds can be used to move the box blanks from the feeding station to a first and second folding station. Critical actuating motions used in the process of folding and advancing the box blanks can be performed at a different speed than other non-critical actuating motions.

### CROSS-REFERENCE TO RELATED APPLICATIONS

This is a continuation-in-part application of U.S. Ser. No. 13/270,354 , filed on Oct. 11, 2011, whose entire contents are hereby incorporated by reference.

### BACKGROUND OF THE INVENTION

1. Field of the Invention

The present invention relates generally to apparatus and methods for folding paper boxes and, more specifically, to apparatus and methods for providing accurate and high-speed mechanical placement of box blanks relative to automated folding mechanisms in order to increase production rates while still creating boxes having good structural integrity.

2. Description of Related Art

During the manufacture of boxes, box blanks are advanced along a paper line for diverse folding and gluing operations. These box blanks usually have “score lines” and “fold lines” that are used to divide the blank into various sections which may include major and minor flaps that can be folded and glued together to form the finished box. During folding operations, the sections and flaps are folded about the score lines and fold lines to produce the sides, top and bottom of a completed box. The folding operations are usually accomplished by automated machinery designed to place a sufficient amount of glue or adhesive on select portions of the box blank along with actuating mechanisms which are specifically designed to contact and fold the various flaps and tabs that are pre-formed on the blank. The folds and tabs of the blank also may be required to be pressed for a time duration to effect a satisfactory glued joint to produce the completed box structure.

In certain box structures, there is often a need for precise placement of the folds and tabs relative to the remaining blank in order to compete a box having strict dimensional tolerances. As such, the machinery used to fold and form the completed box structure must be able to properly fold the blank along the fold lines and score lines to achieve a box that will withstand the burst strength associated with that particular box. Boxes are designed for numerous applications and usually require appropriate strength for a given application. For example, boxes or “flats” used for holding perishable food products, such as vegetables and fruit, often require the boxes to be stacked one upon another for shipping purposes. These type of boxes thus may require additional support structure to handle the weight that may be exerted on the box once stacked. These type of boxes also may require special structural flaps and openings to engage another box that may be stacked upon it. Accordingly, such boxes that are improperly folded and glued can result in box collapse which can cause an avalanche effect to boxes that are stacked on top of such a defective box.

Prior art apparatus for folding preformed blanks into boxes include conveyor based apparatus that engages one or more central panels of the blanks and advances the blanks along the paper line. Continuous folding belt systems can work quite well with thin cardboard or boxes. However, operating problems can result when these folding belt systems are used to fold flaps onto panels of corrugated cardboard blanks After a blank is folded along a score line parallel to the grooves and ridges, the actual fold line may skew with respect to the score line. When the fold line skews, the flap may not register properly with the central panel. This is particularly evident in conventional paper box folding machines using single folding belt systems. Often, it becomes difficult to compensate for the variations in the folding characteristics introduced by shifts in the position of the score line relative to the ridges and valleys formed on the blank, particularly on a blank-by-blank basis.

Moreover, it can be difficult to maintain the belt velocity of the folding belt system, both in speed and direction, relative to the speed and direction of the surface of the blank as it travels along the paper line. If relative motion occurs between the folding belt and the surface of the blank, surface scuffing can occur. As the folding belt system usually engages the exterior surface, any such scuffing can mar the finished surface of the carton or any printing on the carton. Any such marring may produce an unusable box.

Other prior box folding equipment include mechanical rollers which are used to move the blanks through the various folding mechanisms. Slippage between the rollers and the blanks is possible which can cause the box blank to be slightly misaligned with the folding equipment possibly causing misaligned or skewed construction of the finished box. Box folding machines which utilize mechanical drive systems such as rollers for moving the blanks in a continuous fashion can be somewhat bulky and heavy as well.

One of the problems associated with prior art box folding equipment stems from the fact that most of such equipment are solid drive type machines which generally causes the line of folding and advancing machinery to operate at a single speed or a small range of speeds. As a result, it is often difficult to increase productions speeds for such equipment. When production speeds are increased to achieve a higher production rate, such equipment is usually more susceptible to misaligning the box blanks respective to the folding components of the machinery. This misalignment can lead to higher defective boxes being formed.

Additionally, the size and shape of the box blanks can present alignment problems when feeding the box blanks into the various folding mechanisms of the production line. Often, the partially-folded box blanks must be quickly advanced into a sequence of folding mechanisms and may require precise alignment in order to be properly fed into the folding mechanism. Box blanks are often constructed with individual panels and flaps which may be formed in an initial folding operation which then must enter into other folding mechanisms without jamming. Given the speeds at which box blanks can be produced, there should be equipment associated with the various folding mechanisms of the production line which help to prevent or minimize “jam ups” from occurring. Accordingly, equipment which allows intricately-formed box blanks to be freely and quickly advanced along the production line helps to maintain high production speeds.

Inevitably, box jam ups will occur on any production line. In some instances, the jammed box blank must be cut and physically removed from the folding equipment. This can take considerable time which will reduce production speeds. Therefore, there is a need for box-folding equipment which allows the operator to remove any jammed blanks as quickly as possible. Moreover, the equipment should provide a fast means for removing jammed box blanks without compromising the safety of the operator removing the jammed blanks

Thus, a need exists for apparatus and methods for setting-up box blanks in a manner to insure that the partially-folded box blanks can be feed into various folding equipment along the production line without causing jam ups. Also, a need exists for apparatus and methods for increasing production speed while still providing accurate mechanical placement of box blanks relative to the folding equipment. Additionally, there is a need for a box folding apparatus which allows the operator to quickly and safely remove jammed up box blanks from the production equipment. It would be beneficial if certain functions of the high speed machinery could be run at different speeds to increase the overall production rate attainable by the machinery. The present invention satisfies these and other needs.

### SUMMARY OF THE INVENTION

The present invention provides a novel box folding apparatus for folding box blanks into completed boxes which provides mechanisms for properly aligning the partially-folded box blanks being feed into the various folding mechanisms of a high speed production line. The present invention can be used, for example, with production equipment which utilizes separate servo systems that independently control the various actuating drive mechanisms associated with the advancing and folding of the box blanks along the production line. Such equipment is described in co-pending patent application Ser. No. 13/270,354, filed on Oct. 11, 2011, whose entire contents have been incorporated by reference herein. The production equipment disclosed in this co-pending patent application allows certain actuating drive mechanisms to be operating at different speeds in order to reduce the lag time normally associated with prior art solid drive box folding machinery which normally operate at a single speed. Such equipment allows certain critical actuating motions used in the process of folding and advancing the box blanks to be performed at lower speeds than other non-critical actuation motions that can be easily performed at much higher speeds to increase the overall production speed.

In one aspect of the present invention, the apparatus includes a feeding station with a hopper assembly for holding a stack of box blanks therein. A feed assembly is associated with the hopper assembly for engaging a box blank in the hopper assembly and moving it to a first feed position. The feed assembly can utilize, for example, a vacuum source and components adapted to make releasable contact with the box blank in the hopper assembly and mechanisms that draw the box blank into the first feed position. The hopper assembly includes a number of pre-fold shoes which are designed to cause one or more panels or flaps of the box blank to be initially folded as the box blank is being moved from the hopper assembly to the first feed position. In this fashion, the act of moving each box blank into the first feed position initiates the folding operation of the box blank. The feeding station includes a swing guide assembly designed to provide an abutting surface that is adapted to make contact with the flaps/panels of the box blank which has been initially folded by the pre-fold shoes. In this regard, certain panels or flaps of the box blanks can be initially folded, for example, to an upright position relative to the remaining portion of the box blank when placed into the first feed position. The swing guide is designed to abut against the upright panel or flap to help maintain the panel or flap in the upright position as the partially-folded box blank is advanced into an adjacent folding station. This guide rail can be moved between an engaged position in which the guide rail contacts the upright panel/flap of the box blank and a cleared position in which the guide rail is moved out of the area defining the first feed position to allow another box blank to be advanced therein. The swing guide assembly can be synchronized with the feed assembly of the hopper assembly to move the guide into the cleared position as the feed assembly moves to engage the next box blank in the hopper. As the feed assembly moves the box blank into the first feed position, the swing guide assembly will simultaneously move the guide rail into the engaged position to make contact with the raised panel(s) of the box blank. The guide rail remains in place holding up the panel of the box blank as it is advanced to adjacent folding equipment. In one aspect of the invention, this swing guide assembly can be associated with the actuating drive controlled by a servo system disclosed in the above-referenced co-pending patent application which moves the partially folded box blank into the adjacent folding stations.

In another aspect of the present invention, the apparatus includes a folding station having mechanisms for folding other portions of the box blank. In one aspect of the present invention, the folding mechanism(s) can be mounted to the main frame of the apparatus via actuating components such as, for example, pneumatic cylinders, which allow the operator to lift the folding mechanisms from box blanks being folded at that folding station. Thus, in the event that a box blank should become jammed within the folding mechanism, the mechanism(s) can be simply lifted off the jammed box blank a sufficient distance to allow the operator to easily and safely remove the box blank from the folding station. This mechanism eliminates the need for the operator to cut and dislodge the box blank from the folding mechanism and provides a safe mechanism for removing jammed box blanks from the production equipment. In one aspect of the invention, this jam-removal mechanism can be associated with the actuating drive mentioned above.

In another aspect of the present invention, the folding station may include an actuating drive associated with the folding mechanism(s) which is also controlled by another servo system. In this embodiment, the actuating drive moves a forming mandrel using a forward linear stroke which allows the forming mandrel to contact and move the box blank from a second feed position into the folding mechanism. The return linear stroke of the actuating drive then moves the forming mandrel back to the feed position to again advance another blank into the folding mechanism. Since a servo system is utilized, variable speeds can be developed to move the forming mandrel and box blank at a suitable speed to allow the blank to properly enter the folding mechanism. The speed of the return stroke can be increased since placement of the box blank is not an issue in the return stroke. The forming mandrel is used with a particular fold mechanism that includes compression assemblies which provide the compression force that maintains particular folds of the box blank together for a sufficient time duration to allow the glue which has been applied to the box blank to dry. Accordingly, the compression has to be applied quickly and at particular points of the partially formed box to achieve a suitable bond. In one aspect, the compression assembly includes an end paddle and a side paddle that contact the box blank and press particular portions of the blank against a compression plate(s) of the forming mandrel. Such compression assemblies can be positioned, for example, to apply compressive forces at the flaps/panels forming the four corners of the finished box. The angles at which these end and side paddles contact the box blank can be varied, as needed, for particular shaped box blanks In one aspect, a side paddle and end paddle can be paired together on a single compression assembly to create, for example, one corner of the box. Several of such compression assemblies can be positioned relative to each other to fold the remaining corners of the completed box. These compression assemblies can be mounted on a positioning mechanism which allows the operator to easily move and position the compression assemblies to fold different sized and shaped box blanks.

In one aspect of the present invention, two servos can be associated with the advancing feed of the box blanks from the feeding station into the folding station(s) and the feeding of the box blank into the folding mechanism. Since two dedicated servo system can be used to control the actuating speeds of the two actuating drives, the production line can be run at different speeds, and can be less susceptible to jam ups, as is explained in detail in the co-pending patent application. The use of the previously described production equipment of the co-pending patent application, with the new apparatus disclosed herein, produce a production line which is both fast and reliable.

These and other advantages of the present invention will become apparent from the following detailed description of preferred embodiments which, taken in conjunction with the drawings, illustrate by way of example the principles of the invention.

### BRIEF DESCRIPTION OF THE DRAWINGS

FIG. 1 is a perspective view of one embodiment of a box folding apparatus made in accordance with the present invention.

FIG. 2 is a side elevational view of the box folding apparatus of FIG. 1 with protective coverings removed to better show the assemblies forming the present invention.

FIG. 3 is top plan view of the box folding apparatus of FIG. 1.

FIG. 4 is an end elevational view of the box folding apparatus of FIG. 1.

FIG. 5 is an end elevational view of the box folding apparatus of FIG. 1.

FIG. 6 is a perspective view of an embodiment of a feeding station which forms one of the three stations of the box folding apparatus of the present invention.

FIG. 7 is a perspective view of an embodiment of a first folding station of the box folding apparatus of the present invention.

FIG. 8 is a perspective view of the embodiment of the first folding station looking from the second folding station of the box folding apparatus of the present invention.

FIG. 9 is a partial perspective view showing the entrance of the first folding station of FIGS. 7 and 8.

FIG. 10 is a partial perspective view showing the rear pusher assembly of the actuating drive as it is positioned within the first folding station.

FIG. 11 is a perspective view showing an embodiment of a second folding station of the box folding apparatus of the present invention.

FIG. 12 is a perspective view showing the folding mechanism of the second folding station with the forming mandrel removed to better show the associated folding mechanism.

FIG. 13A is a perspective view of the composite actuating drive with the front and rear pusher assemblies mounted thereto.

FIG. 13B is a perspective view of the actuating drive shown in FIG. 13A.

FIG. 13C is a perspective view of one of the front pusher assemblies of FIG. 13A.

FIG. 13D is a perspective view of the rear pusher assembly of FIG. 13A.

FIG. 14A is a perspective view showing a box blank placed in the first feed position of the feeding station.

FIG. 14B is a perspective view showing the box blank of FIG. 14A with the guide rail of the swing guide assembly in the engaged position.

FIG. 14C is a perspective view showing one embodiment of the swing guide assembly made in accordance with the present invention.

FIG. 15 is a side view showing the feeding station and first folding station.

FIG. 16 is an embodiment of a lamination assembly which forms one of the folding mechanisms associated with the first folding station.

FIG. 17 is a perspective view of the folding mechanisms associated with the first folding station and the movable support frame.

FIG. 18A is a side elevational view showing the support frame attached to the folding mechanism of the first folding station as the folding mechanism is in the engaged position.

FIG. 18B is a side elevational view showing the support frame and the attached folding mechanism raised into the raised or disengaged position.

FIG. 19A is a perspective view of one embodiment of a folding mechanism associated with the second folding station of the present invention.

FIG. 19B is a perspective view showing one of the compression assemblies of FIG. 19A.

FIG. 20 is a schematic of the control unit system used with the various components of the assemblies forming the apparatus of the present invention.

### DETAILED DESCRIPTION OF THE PREFERRED EMBODIMENTS

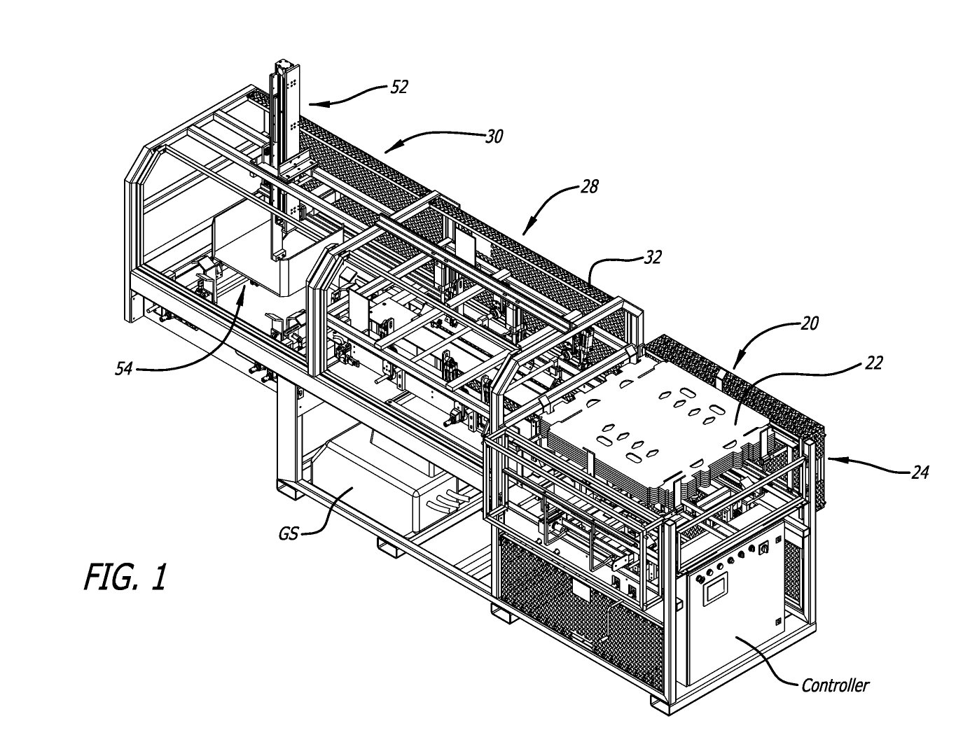

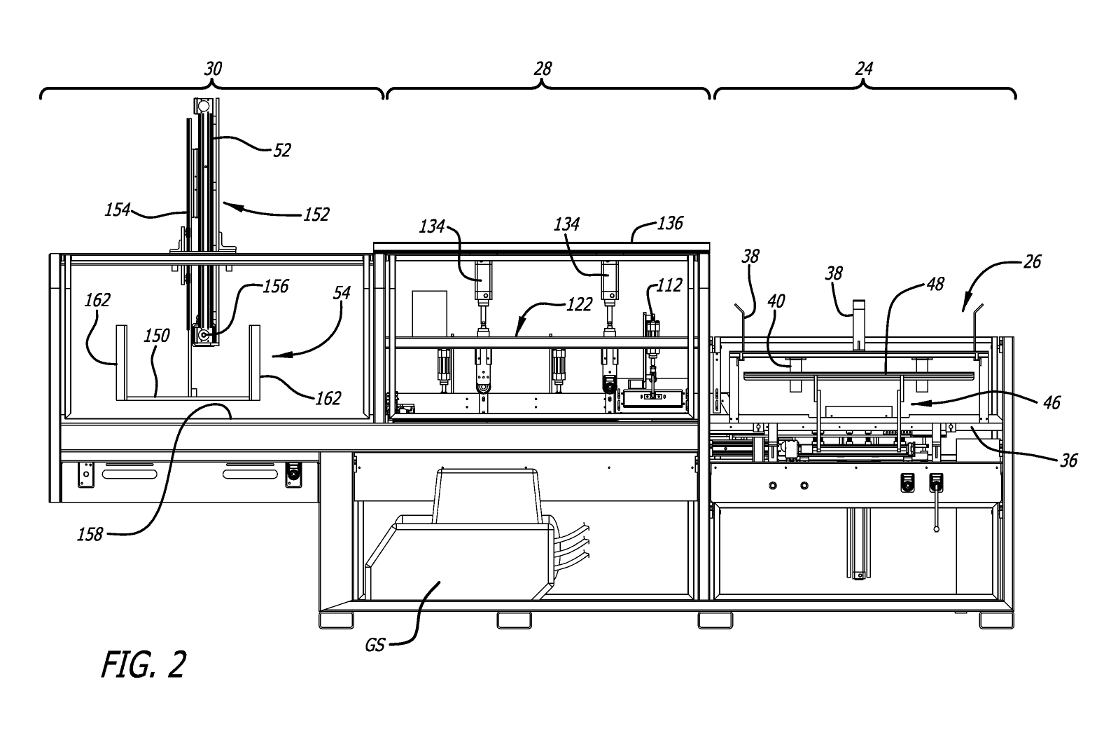

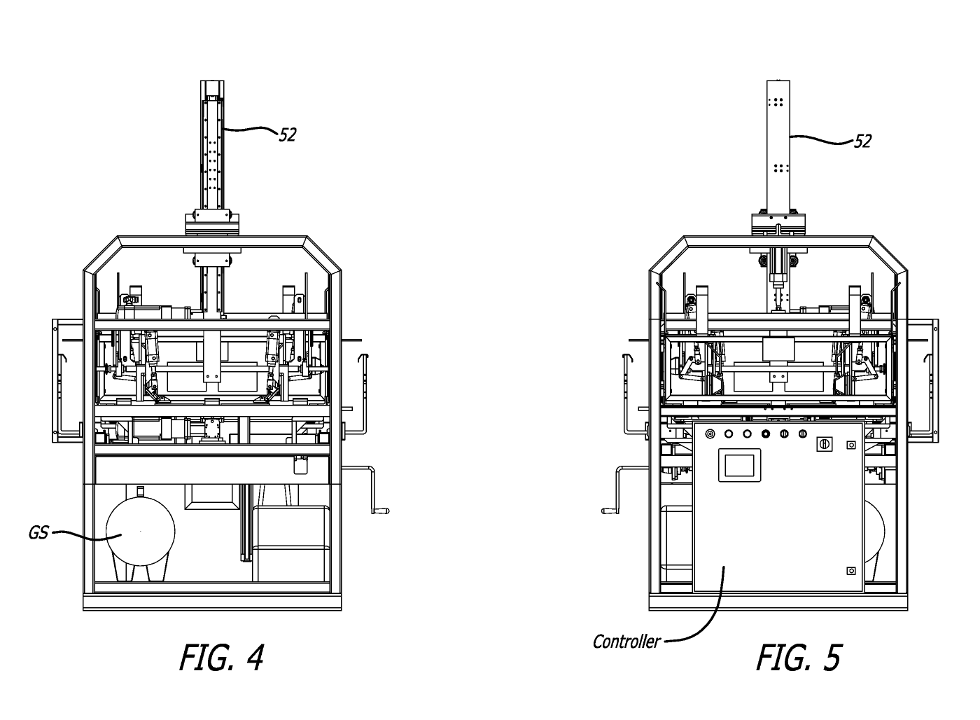

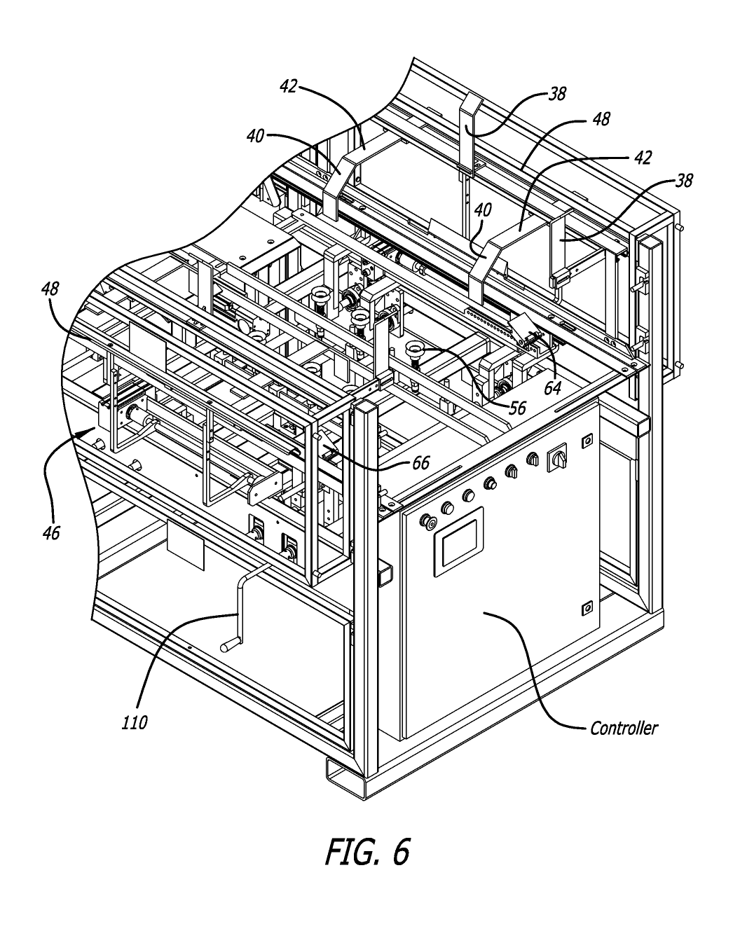

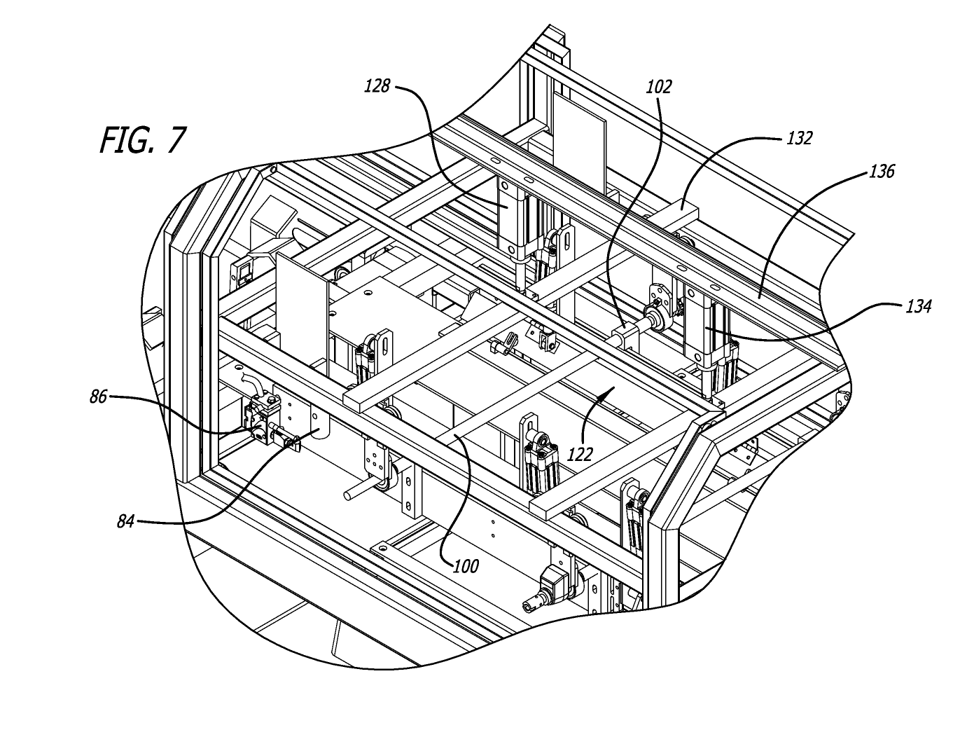

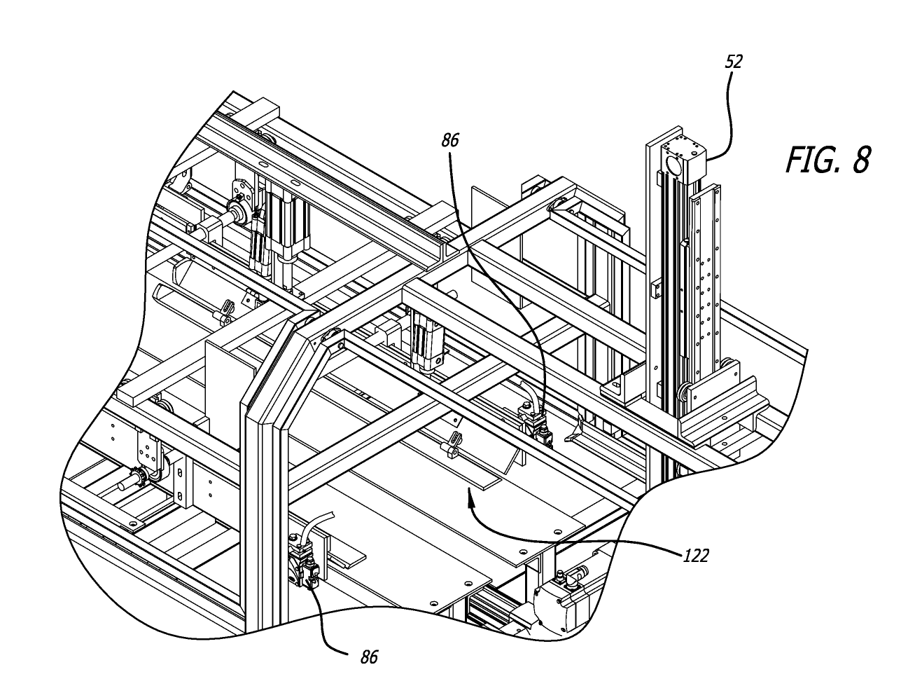

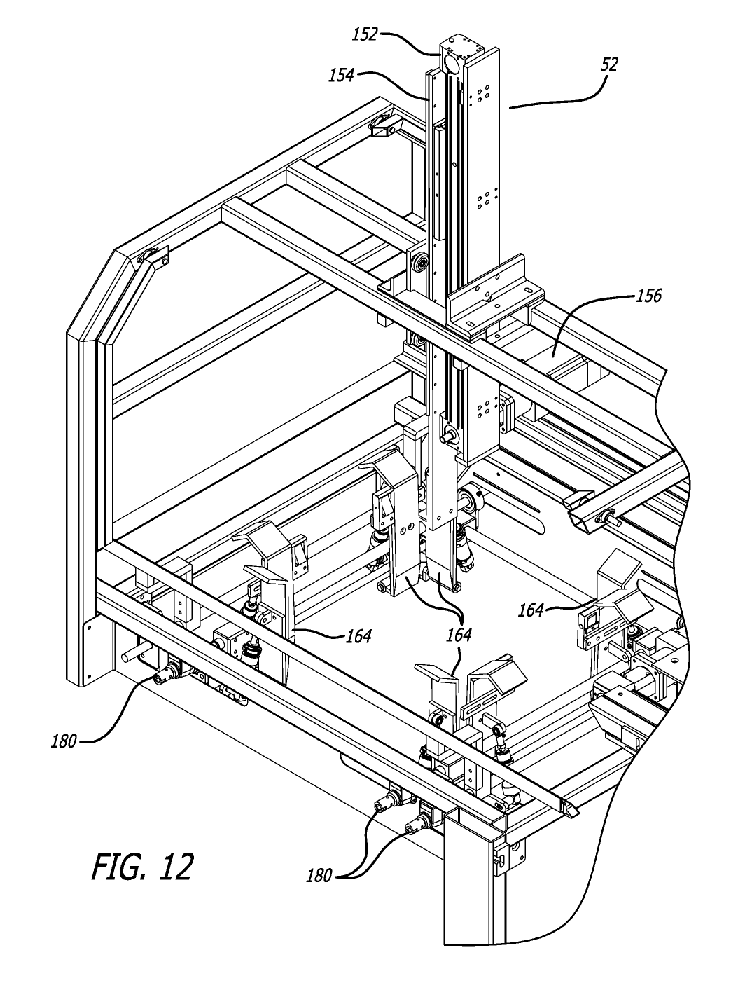

An embodiment of a novel box folding apparatus 20 made in accordance with the present invention is shown generally in FIGS. 1-5. More detailed drawings of the various actuating drives and folding assemblies making up the box folding apparatus 20 are provided in FIGS. 6-19 and will be described in greater detail below. The particular embodiment of the box folding apparatus 20 disclosed herein is specifically directed to folding a particular sized and shaped box blank. It should be appreciated that the present invention can be used with various folding mechanisms and drive assemblies to fold any number of different sized and shaped box blanks to form a finished box.

Referring specifically to FIG. 1, a commercial grade box folding apparatus 20 made in accordance with the present invention is shown. FIG. 1 shows a stack of box blanks 22 which are folded by various folding mechanisms located within the apparatus 20 and eventual are folded into finished boxes. This particular apparatus 20 utilizes three stations which advance and fold the box blanks 22 into the finished box. These stations include a feeding station 24 for delivering and feeding box blanks 22 into the folding mechanisms associated with the apparatus 20. The box blanks 22 are shown stacked in a hopper assembly 26 which forms a portion of the feeding station 24. Directly adjacent to the feeding station 24 is a first folding station 28 which has particular folding mechanisms mounted therein for folding at least a portion of the box blank 22. Next, directly adjacent to the first folding station 28 is a second folding station 30 which receives the partially-folded box blank from the first folding station 28 and includes particular folding mechanisms which provide the final folding operations to complete the formed box. In this particular embodiment, the finished boxes (not shown) can drop from the folding mechanism of the second folding station 30 directly onto, for example, a conveyor belt system (not shown) which moves the boxes to another location or to another production line, for example, a conveyor system manually or mechanically packing goods into the boxes.

In FIG. 1, the box folding apparatus 20 is shown with protective covers 32 located at various positions, particularly around the folding stations 28 and 30 in order to keep worker's hands and objects away from the moving parts of the various folding mechanisms mounted within these stations. It should be appreciated that these protective covers 32 can be in the form of hinged panels which allow the operator easy access to the machinery for servicing. It should be appreciated that the front protective panels have been removed from the apparatus as is shown in FIG. 1. In an industrial setting, both sides of the apparatus would include protective panels. The remaining figures of the box folding apparatus 20 will be shown without these protective panels for ease of viewing the components mounted in the folding stations. Additionally, the actual box folding apparatus would include various pneumatic lines, adhesive lines, hydraulic lines, and associated electrical wiring to connect the various components together to create a working apparatus. Again, for ease of viewing, such lines and wiring, including pneumatic regulators and pneumatic sources have been omitted from the drawings to allow the reader to better see the mechanisms and drives associated with the apparatus 20.

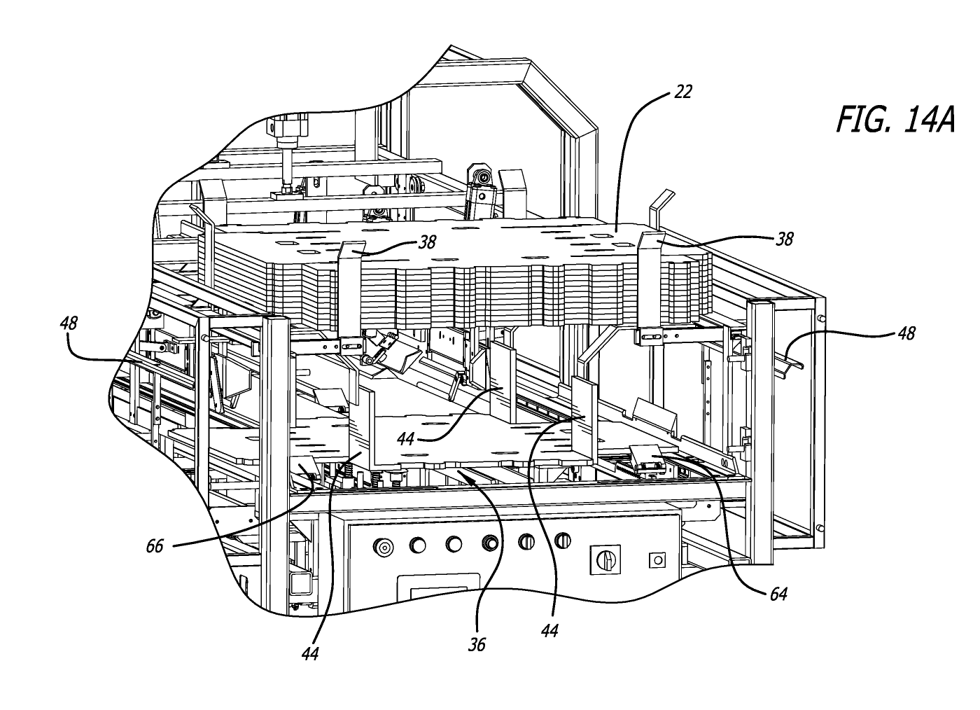

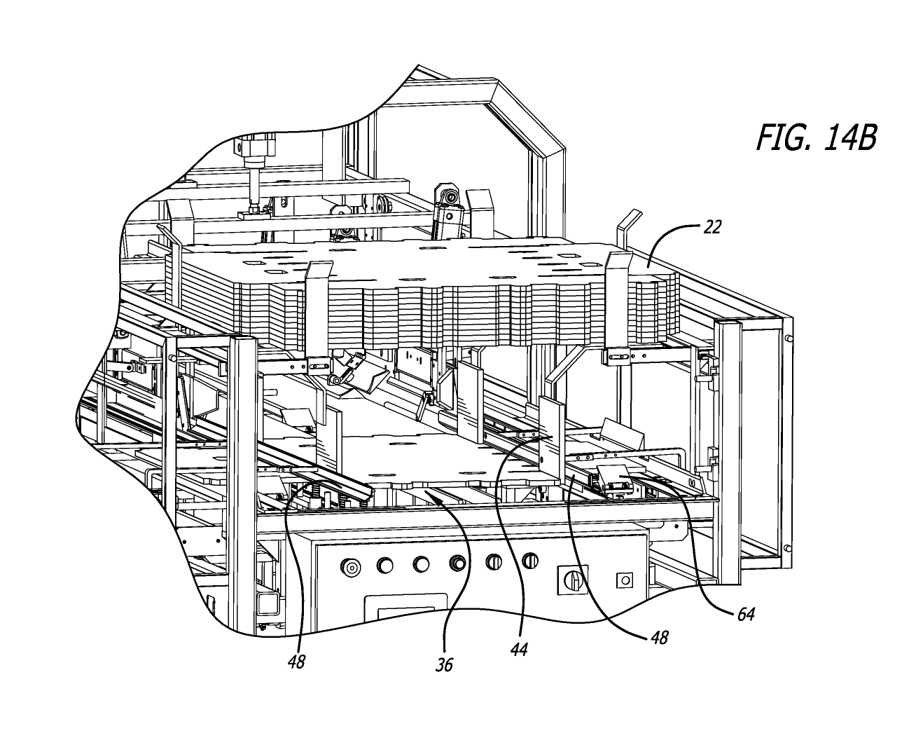

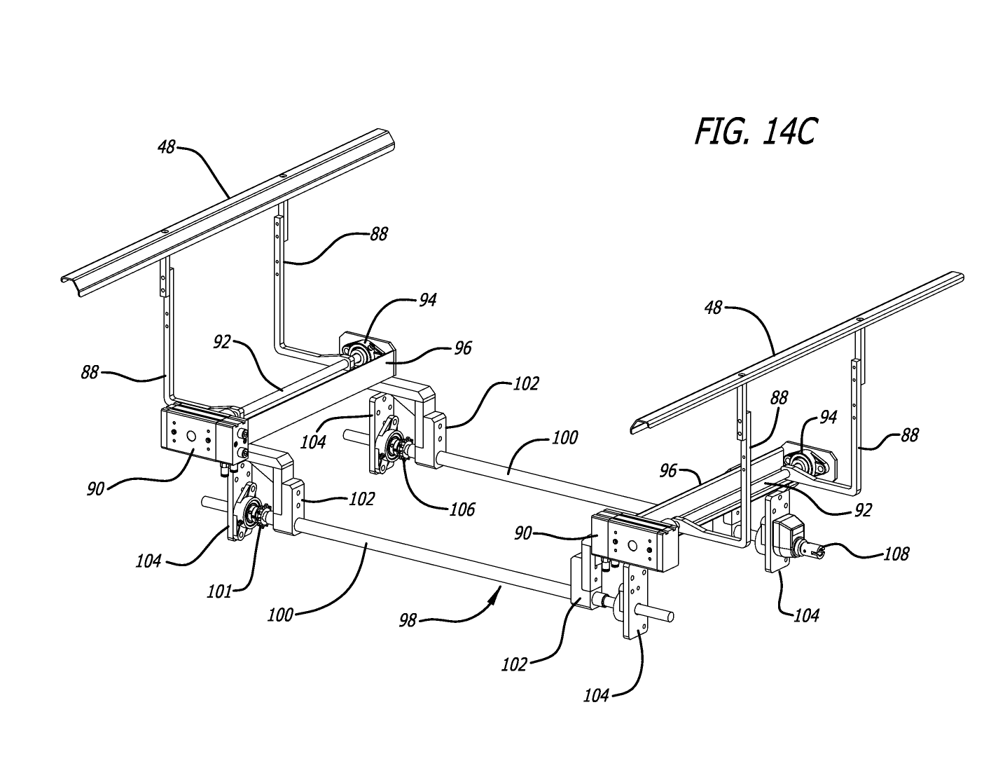

Initially, an operator feeds a stack of box blanks 22 into the hopper assembly 26 of the feeding station 24 located at one end of the box folding apparatus 20. The hopper assembly 26 is designed to hold the stack of box blanks 22 for placement on a first feed position 36 located on the feeding assembly where the box blank will then be advanced into the first folding station 28 (see FIGS. 14A and 14B). In the particular embodiment disclosed herein, the hopper assembly 26 is a bottom fed device which means that the bottom most box blank in the stack is moved in a downward fashion onto the first feed position located on the feeding station 24. It should be appreciated that top fed hoppers and related apparatus for feeding the top most box blank could be used as well as manual feeding of individual box blanks into the feeding station. However, in this particular embodiment, bottom feeding from the hopper assembly 26 provides for a quick and easy mechanism for feeding box blanks 22 into the folding machinery. It should be appreciated that still other hopper assemblies could be used with the present invention.

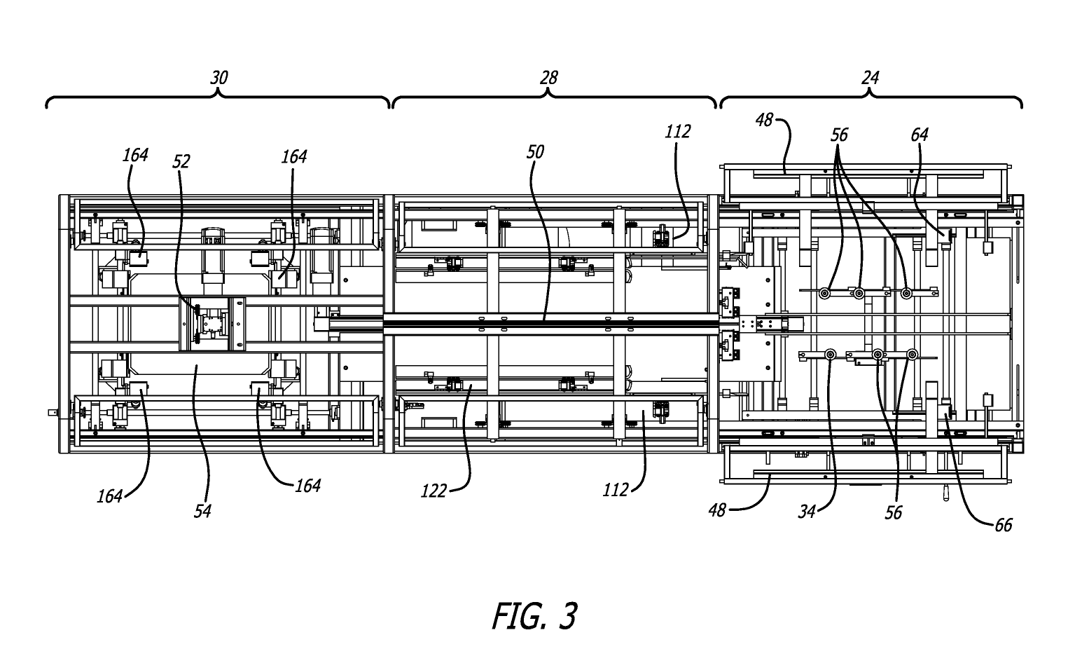

The bottom box blank of the stack can be moved from the hopper assembly 26 to the first feed position utilizing, for example, a vacuum feed assembly 34. FIG. 3 shows a good plan view of the positioning of the vacuum assembly 34 on the feeding station 24. In use, the vacuum assembly 34 moves the blank (not shown in FIG. 3) into the first feed position 36 on the feeding station 24. This first feed position 36 is best shown in FIGS. 14A and 14B in which a single box blank has been positioned ready to be advanced into the first folding station 28. Still other ways of feeding the apparatus can be implemented.

Referring now to FIG. 6, the hopper assembly 26 includes a number of hopper side panel guides 38 which are extend parallel and opposite from each other to form a defined width which matches the size of the particular box blanks 22 to be folded. These side panel guides to create a holding area for receiving the stack of box blanks 22. The hopper assembly includes a at least one pre-fold shoe 40 used to initially bend a portion of the box blank as the box blank is moved from the hopper assembly 26 to the first feed position 36. In the particular embodiment disclosed herein, the hopper assembly 26 includes four pre-fold shoes 40 which are placed at locations where a flap or panel of the box blank is to be initially folded. Each pre-fold shoe 40 has a flat support surface 42 (see FIG. 6) which is used to support the stack of box blanks 22 in the hopper assembly 26. FIGS. 14A and 14B show how the pre-fold shoes contact flaps or panels 44 formed on each box blank 22 to fold the panel 44 into a upright position.

The vacuum feed assembly 34 can be synchronized with a swing guide assembly 46 that includes a guide rail 48 that will abut against the raised panel 44 of the box blank 22 once the panel 42 has been pre-folded in the upright position. This swing guide assembly 46 helps to maintain the panel 44 in its upright position as the box blank is advanced into the first folding station 28. It should be appreciated that the box blank is pre-cut with fold lines and the like to help achieve that exact amount of fold needed to create each finished box. In this regard, while the panel 44 may be initially folded upright by the pre-fold shoe 40, the resiliency and composition of the box will cause the panel 44 to bend back to the flattened position once the shoe 40 no longer makes contact with the panel 44. Accordingly, the guide rail 48 will maintain the panel 44 upright as the blank 22 is advanced into the folding mechanisms of the first folding station 28. The swing guide assembly 46 is shown in greater detail in FIG. 14C and will be described in greater detail below.

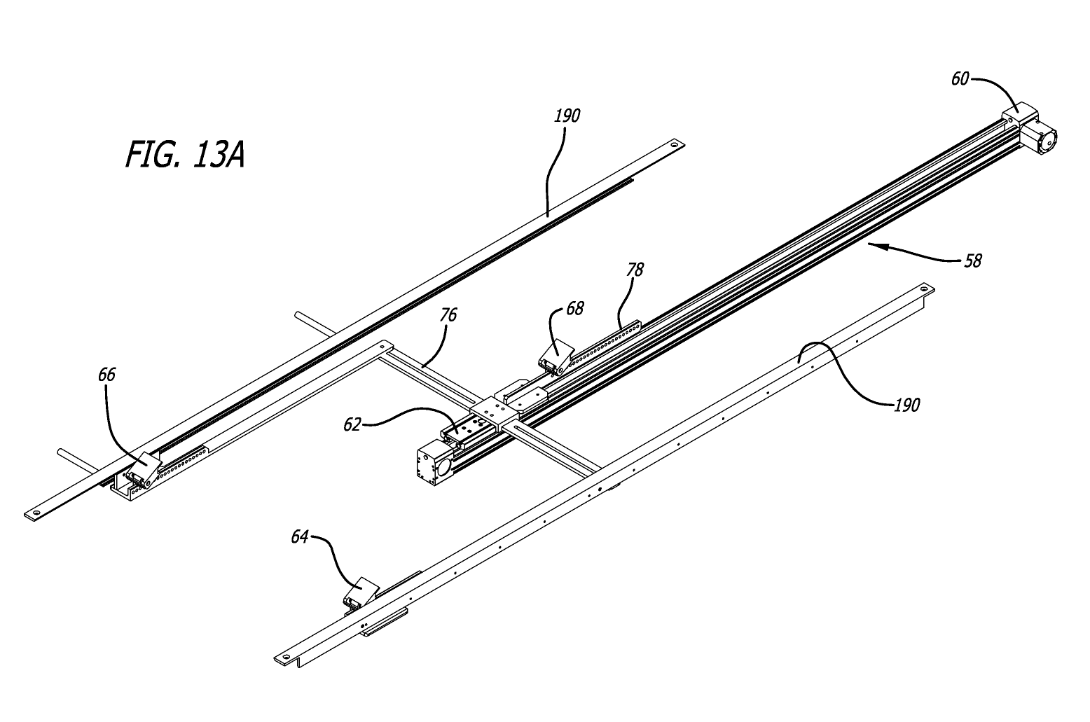

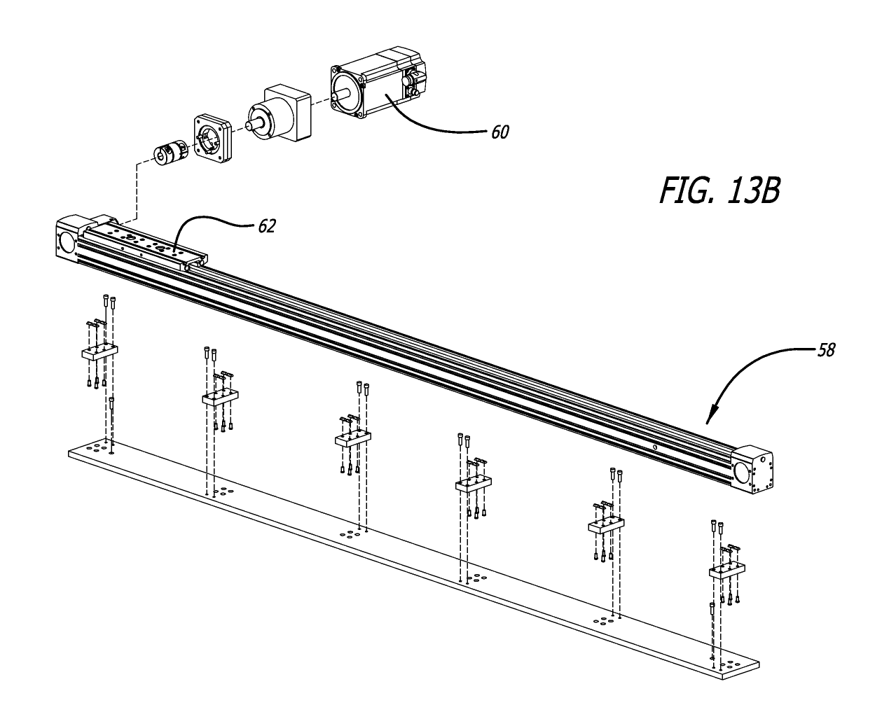

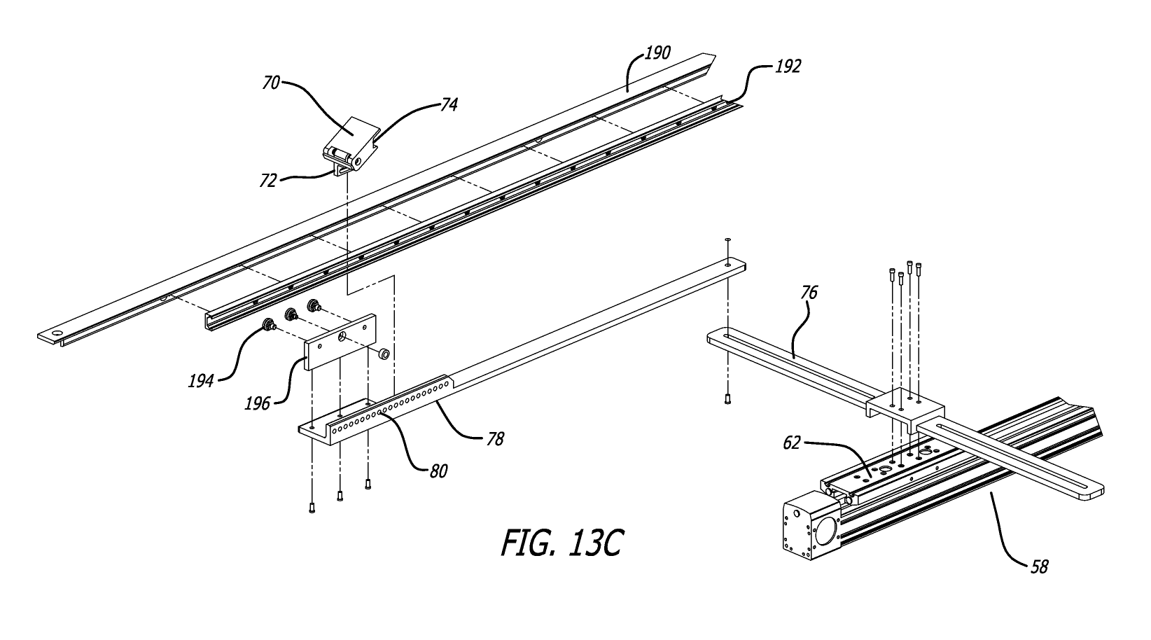

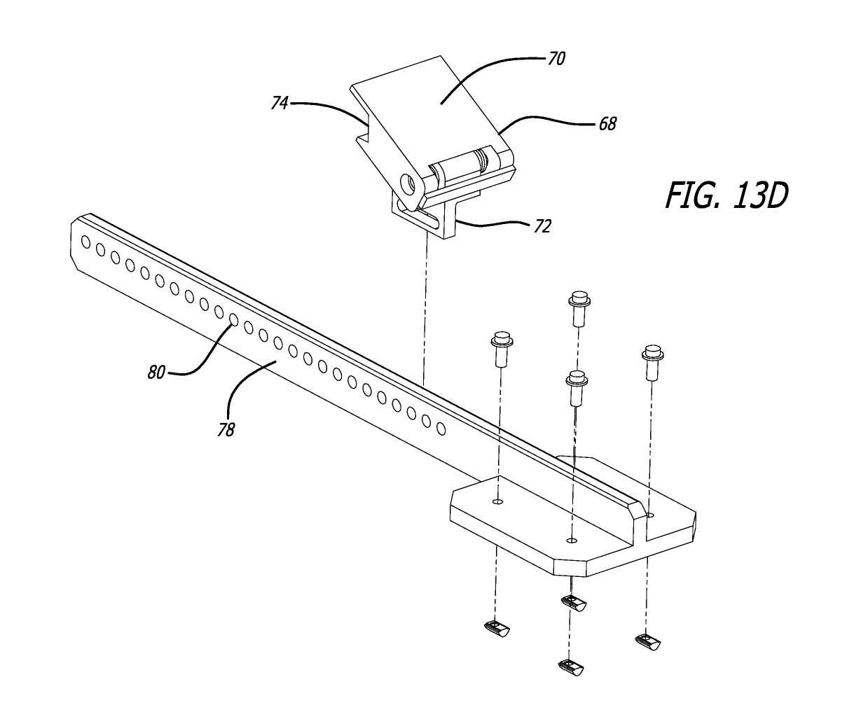

Once a box blank 22 has been placed onto the first feed position 36 of the feeding station 28, an actuating drive 50 (shown in greater detail in FIGS. 13A-13D and described in greater detail below) associated with the box folding apparatus 20 which will move the box blank 22 into proper position within the first folding station 28. FIG. 3 shows a good plan view of this actuating drive 50 as it is positioned on the feeding station 24 and the first folding station 28. The actuating drive 50 is controlled by a servo system which provides variable speed control to allow the actuating drive 50 to move at different speeds during the feeding process. For example, in the present embodiment, the actuating drive 50 provides a forward linear stroke to move the box blank 22 from the first feed position 36 into the first folding station 28. The actuating drive 50 can advance the box blank 22 at a first speed which is fast enough to keep the production speed high, but is slow enough to ensure proper placement of the box blank 22 with respect to the folding mechanisms associated with the first folding station 28. Thereafter, components associated with the actuating drive 50 must be returned to the initial position to engage another box blank which has, or is in the process of, being placed into the first feed position 36. This return stroke of the actuating drive 50 can be performed at an increased speed from the first forward stroke since proper blank placement in not an issue when returning the actuating drive it its original position to advance another box blank. In this fashion, the servo system can varying the speed of the actuating drive to increase the overall speed of this particular operation without compromising the accuracy needed in positioning the box blank. The linear stroke achieved by the actuating drive 50 is shown as a preferred way for advancing the blank into the first folding station. However, still other types of actuating drives could be utilized with a servo system for advancing the box blanks into the first folding station 28. It should be appreciated that the actuating drives are not limited to linear actuators.

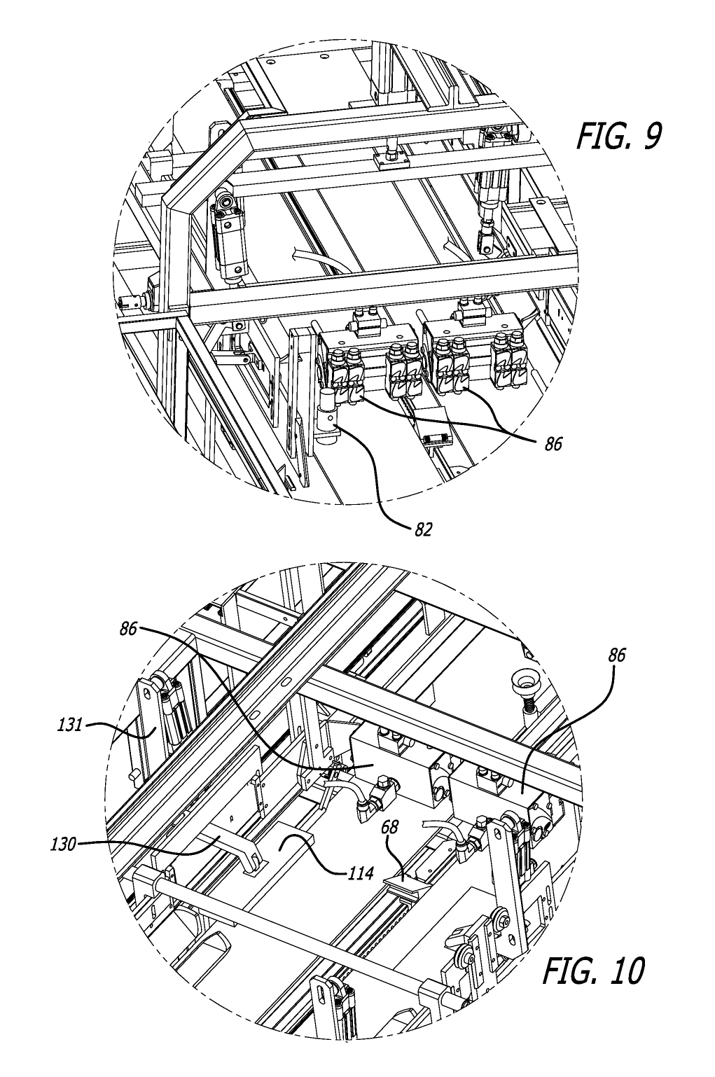

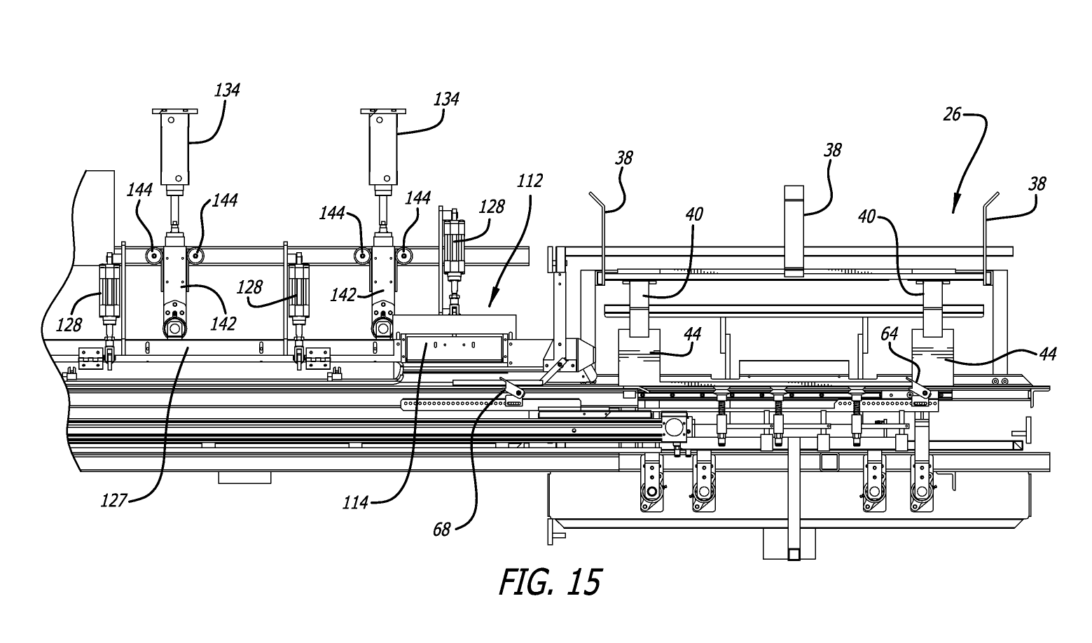

Once the box blank 22 has been positioned within the first folding station 28, the associated folding mechanisms will be activated to at least fold some of the flaps/tabs/panels formed on the box blank. In the particular first folding station described herein, the four panels 42 are glued and folded against a portion of the blank to partially create a supporting corner structure which increases the strength of the finished box. It should be noted that a glue assemblies located at the entrance of the first folding station 28 (FIG. 9) are utilized to selectively apply a specific amount of glue or adhesive to the blank prior to the folding operation. The particular folding equipment that could be used in this first folding station 28 is disclosed in greater detail below and is generally disclosed in FIGS. 15-18.

After the folding operation is completed in the first folding station 28, the partially-folded box blank 22 can now be advanced to the second folding station 30 where additional folding of the blank is performed by the equipment associated with this particular folding station. In the present embodiment, the same actuating drive 50 which moves the box blank into the first folding station 28 is also used to advance the partially-folded blank from the first folding station 28 into the second folding station 30. In this manner, a separate apparatus for advancing the blank along the line is eliminated.

This second folding station 30 includes folding mechanisms along with a second actuating drive 52 that is utilized to position the partially-folded box blank from a second feed position into the folding mechanism. This second actuating drive 52, like the first-mentioned drive above, is controlled by a servo system which brings variable speed capability to this step of the folding operation. The servo system which controls this second actuating drive 52 operates independently from the servo system controlling the first actuating drive 50 in that both actuating drives 50 and 52 can be set at individual speeds in order to achieve the operations performed by these drives 50 and 52. For this reason, these drives 50 and 52 may require a separate servo system in order to achieve the necessary variable speed requires for that particular drive. The separate servo systems would still have to coordinate with each other to only allow for advancement of box blanks when the next folding mechanism is ready to accept the blank. Otherwise, blanks could be advanced into the next station when it is not ready to accept the blank which can improperly jam up the apparatus 20.

It should be appreciated that the servo systems are controlled by a central processing unit to allow for blank advancement only when the next station is ready to accept the blank. The use of a servo system for moving and controlling the movement of the blanks along the folding mechanisms allows each drive to operate at the speed needed for that drive. The use of photo optical sensors with each servo system will ensure that blanks are not advanced into another piece of machinery until that machinery is ready to accept the blank. In this fashion, the feeding/folding operation cannot advance blanks until the machinery is ready to accept the blank.

As the partially-folded box blank moves from the first folding station 28 to the second folding station 30, glue or adhesive can again be applied to select areas of the partially-folded blank. The glue applicators can be located at various positions in the first folding station. Normally, glue applicators can be positioned at the entrance of the first folding station if the first folding step requires the presence of glue on the flap(s) or tab(s) being folded. In the particular embodiment disclosed herein, the second actuating drive 52 moves a forming mandrel 54 (shown best in FIGS. 1, 2 and 11) to move the partially-folded blank from a second feed position 158 into the folding mechanism associated with the second folding station 30. Again, due to the variable speed control associated with this second actuating drive 52, the box blank can be moved at a reasonable speed into the folding mechanism while the return stroke can be done at a greater speed to increase production speed.

It should be appreciated that more or less folding stations can be utilized depending upon the structure of the box blank which is being folded. For example, some box blanks could be folded at a single folding station which includes a second actuating drive used in accordance with the present invention. Additionally, a box folding apparatus could be built using additional folding stations, particularly when the box blank to be folded includes numerous folding and gluing steps. In this regard, additional actuating drives which are controlled by servo systems could be implemented into the folding operations. Additional actuating drives, such as actuating drive 50, could be used to advance the box blanks along a long line of folding stations when the box blank requires numerous folds. The same principles relating to the actuating drives 50 and 52 would apply to these additional drives as well.

The vacuum assembly 34 utilized to move the bottom most box blank from the stack of blanks utilizes a number of spaced vacuum cups 56 designed to make contact with the bottom most box blank 22 to draw the blank 22 down onto the first feed position 36. As can best be seen in FIGS. 3 and 6, the vacuum assembly 34 utilizes six vacuum cups 56 placed in spaced-apart positions relative to the box blank 22 to allow the cups 56 to contact and engage the blank once the vacuum source (not shown) is applied. With the vacuum cups 56 engaged with the box blank 22, the vacuum assembly 34 can then be drawn downward to bring the bottom blank 22 to the first feed position 36. The vacuum assembly 34 is designed to move up and down to engage the box blanks and move them into the first feed position 36. An actuating motor attached to the vacuum assembly 34 moves the entire unit in an up and down motion. Once the box blank has been drawn down from the hopper assembly 26, the vacuum source could either be shut off or the vacuum assembly could be simply lowered below the feed position to allow the cups to break their vacuum seal with the box blank. The vacuum cups 56 can be positioned along its frame so that the cups 56 are appropriately spaced to engage the box blank 22. The number of vacuum cups 56 can vary along with their positioning depending on the size and shape of the box blank.

Once the bottom box blank has been drawn down into the first feed position 36 on the feeding station, the guide rail 48 will come into contact with each raised panel 44 of the blank. It should be appreciated that two guide rails 48 are used on both sides of the box blank 22 to make contact with the raised panels 44. The movement of the swing guide assembly 46 can be timed with the movement of the vacuum feed assembly 34 as will be discussed in greater detail below to move the guide rails between the engaged position and cleared position. The actuating drive 50 will now advance the box blank 22, with the guide rails 48 in placed, into the first folding station 28.

As can best be seen in FIGS. 13A-13D, the particular actuating drive 50 used with the present embodiment includes a linear drive unit 58 mounted in the feeding station 24 (see FIG. 3) and connected to a servo motor 60 which forms part of the servo system. The linear drive unit 58 is designed to move a slider bar 62 in a forward and backward motion to advance the box blanks into the first and second folding stations 28 and 30. This slider bar 62 includes a pair of front pusher assemblies 64 and 66 (best seen in FIGS. 3, 6, 13A, 13C, 14A and 14B) utilized to engage the front edge of the box blank (as shown in FIGS. 14A and 14B) which has dropped into the first feed position 36 of the feeding station 24 in order to move the blank into the first folding station 28. The slider bar 62 further includes a rear pusher assembly 68 (FIG. 10, 13A and 13D) located a distance away from the front pusher assemblies 64 and 66 which is used to move a partially-folded blank from the first folding station 28 to the second folding station 30. In this regard, when the actuating drive 50 is in operation, the front pusher assemblies 64 and 66 will contact the front edge of the blank while the rear pusher assembly 68 contacts the front edge of a partially-folded blank located in the first folding station 28 to allow it to be advanced into the second folding station 30. Thus, the actuating drive 50 is designed to move two blanks simultaneous during the folding operation.

In operation, as the slider bar 62 moves back in its return stroke to allow the front pusher assemblies 64 and 66 to engage another blank that is being fed from the hopper assembly 30, the vacuum feed assembly 34 has already been moved in position to engage the next blank which will be moved to the first feed position 36. The timing of the feeding operations allow the vacuum assembly 34 to be actuated once the box blank has been cleared from the feed position of the feeding station. In this fashion, the speed of the folding operation can be increased since the actuation of the vacuum feed assembly 34 can be timed and synchronized with the actuating drive to reduce the time needed to feed blanks from the hopper assembly 28. Once the blank has been moved from the feeding station 28 into the first folding station 32, the folding mechanisms associated with the first folding station 32 can be implemented to create the desire amount of fold to the box blank. As is mentioned above, it should be appreciated that the first folding station 28 may include not only folding mechanisms for folding the box but also mechanisms for placing glue/adhesive onto the desired area of the blank.

The structure of the front pusher assemblies 64 and 66, along with the rear pusher assembly 68, is somewhat similar in that a shaped engaging plate 70 is pivotally mounted to a base structure 72. The engaging plate 70 has a formed edge 74 designed to engage the edge of the box blank 22 as the slider bar 62 moves in a forward direction. The plate 70 is pivoted such that as the slider bar 62 moves in the return direction, the plate 70 will pivot in the event that it should make contact with a box blank as the pusher is being moved back into the first feed position. Accordingly, the plate 70 provides a smooth surface which will allow it to slide along the length of the box blank, rather than engage it. As is shown in FIGS. 13A and 13C, the front pusher assemblies 64 and 66 are attached to a cross beam 76 that is attached to the slider bar 62. The rear pusher assembly 68 is mounted to a mounting assembly 78 that is attached to the slider 62. This mounting assembly 78 has a plurality of openings 80 for receiving fasteners which connect the rear pusher assembly 68 to the mounting assembly 78. These openings 80 allow the rear pusher assembly 68 to be moved along its length to properly position the assembly 68 relative to the location of the edge of the box blank. Each of the front pusher assemblies 64 and 66 is also mounted to a mounting assembly 78 (see FIG. 13C) with a number of openings 80 that allow the plate 70 to positioned as may be needed.

The actuating drive 50 utilizes optical sensors 82 and 84 which are strategically placed at the entrance and exit of the first folding station 28. These optical sensors are associated with the servo systems and provide a signal once the box blank 22 begins to enter the first folding station 28 and once it exits it. The signals from these optical sensors can be used in accordance with the glue assemblies 86 which are placed along the folding line to signal when glue should be released onto the box blank. Additional glue assemblies can be used and positioned on the frame of the apparatus as is needed. It should be appreciated that additional optical sensors could be utilized for providing desired signals for other functions that are being controlled during the folding operations.

The structure of one particular embodiment of the swing guide assembly 46 is better shown in FIG. 14C. The swing guide assembly 46 includes a pair of guide rails 48, each of which are attached to a pair of extension arms 88. One of the extension arms 88 of each subset is attached to a rotary drive 90 which is used to rotate the extension arms 88 and guide rails 48. As can be seen in FIG. 14C, each extension arm 88 is attached to a rod 92 which is rotationally mounted in a flange bearing 94 mounted within a support frame 96. The actuation of the rotary drive will turn the rod 92 causing the extension arms 88 and guide rail 48 to move in a arcuate fashion.

Each support frame 96 is attached to a positioning mechanism 98 capable of laterally moving the support frame 96, and hence each guide rail 48, laterally on the feeding station to properly position the guide rails 48 relative to the panel 44. The positioning mechanism 98 includes a pair of threaded rods 100 threadingly connected to support mountings 102 which are, in turn, connected to the support frame 96. Brackets 104 are utilized to connect the positioning mechanism to a portion of the main frame forming the feeding station 24. A chain sprocket 106 is attached to one end of each threaded rod 100 and a pair of sprockets 106 on each rod 100 are connected via a chain (not shown) which causes each threaded rod 100 to move simultaneously when one of the rods 100 is rotated. Accordingly, each support mounting 102 should move laterally and simultaneously along the rod 100 as one of the rods 100 is rotated. A crank coupling 108 placed at one end of one of the threaded rods 100 allows the operator to simple turn a crank 110, shown in FIG. 6, to move the support mounting 102 laterally on the apparatus. Thus, the positioning of each guide rail 48 in the engaged position can be easily accomplished by simply rotating the crank 110.

The movement of the swing guide assembly 46 can be easily timed with the movement of the vacuum feed assembly 34. For example, each guide rail 48 can be moved between an engaged position in which the guide rail of the assembly contacts the upraised panel(s) 44 of the box blank 22 (see FIG. 14B) and a cleared position (FIG. 14A) in which the guide rails 48 are been moved out of the first feed position 36 to allow another box blank to be advanced therein. The swing guide assembly 46 can be synchronized with the vacuum feed assembly 34 of the feeding station 24 to move the guide rails 48 into the cleared position as the vacuum feed assembly 34 moves upward to engage the next box blank in the hopper assembly 26. As the vacuum feed assembly 34 moves the box blank 22 into the first feed position, the swing guide assembly 46 will simultaneously move the guide rails 48 into the engaged position to make contact with the raised panel(s) 44 of the box blank 22 (see FIG. 14B). Once the panel(s) 44 have been raised by the pre-fold shoes 40, the guide rails 48 will be immediately placed in the engaged position abutting against the panel(s) 44. The guide rails 48 remain in place for a short duration as the actuating drive 50 moves the box blank 22 into the first folding station 28. Thus, proper timing of the swing guide assembly 46 with the movement of the vacuum feed assembly 34 should not diminish the speed at which the box blanks are feed into the folding machinery.

Referring now to FIGS. 15-18, the folding mechanisms associated with the first folding station 28 will be discussed in greater detail. In the particular embodiment shown in FIG. 15, the box folding mechanisms are particularly designed to fold the raised panels 44 that are entering the first folding station 28. On the particular box blank disclosed herein, the raised panels 44 form the corner post of the finished box. Accordingly, the folding mechanisms include a pair of folding assemblies 112, each designed to initially bend the raised panels 44 along fold lines (not shown) formed on each panel 44. One folding assembly 112 is located across from the other assembly 112 to allow the assemblies 112 to simultaneously fold the panels 44 located on both sides of the box blank. Each folding mechanism 112 includes articulating folding paddles 114 which engage the raised panel 44 to enable the force developed by the folding panel 114 to properly bend the panel 44 into its desired configuration. Each folding paddle 114 is attached to linkages 118 which allow the folding paddle 114 to articulate in its particular folding motion. An air cylinder 120 is attached to linkages 118 which help to move the paddle 114 though its particular folding motion. A mounting plate 115 is mounted to an arm 116 which holds the air cylinder in place. This mounting plate 115 is, in turn, attached to a lamination side plate described below. Prior to the folding performed by this particular folding assembly 112, a glue assembly 86 located at the entrance of the first folding station 28 (see FIG. 10) applies an appropriate amount of glue or adhesive to the surfaces of the box blank. The folding paddles 114 then provide the necessary compressive forces applied to the box blank. In use, once the box blank is in position, each folding paddle 114 is moves from a neutral position to break the fold lines on each panel 44. The paddle 114 provides a brief compressive force for a short duration to allow the folded portions of the panel 44 to bond together. The folding paddle 114 is then moved back to its neutral position to allow another panel of the box blank to be folded.

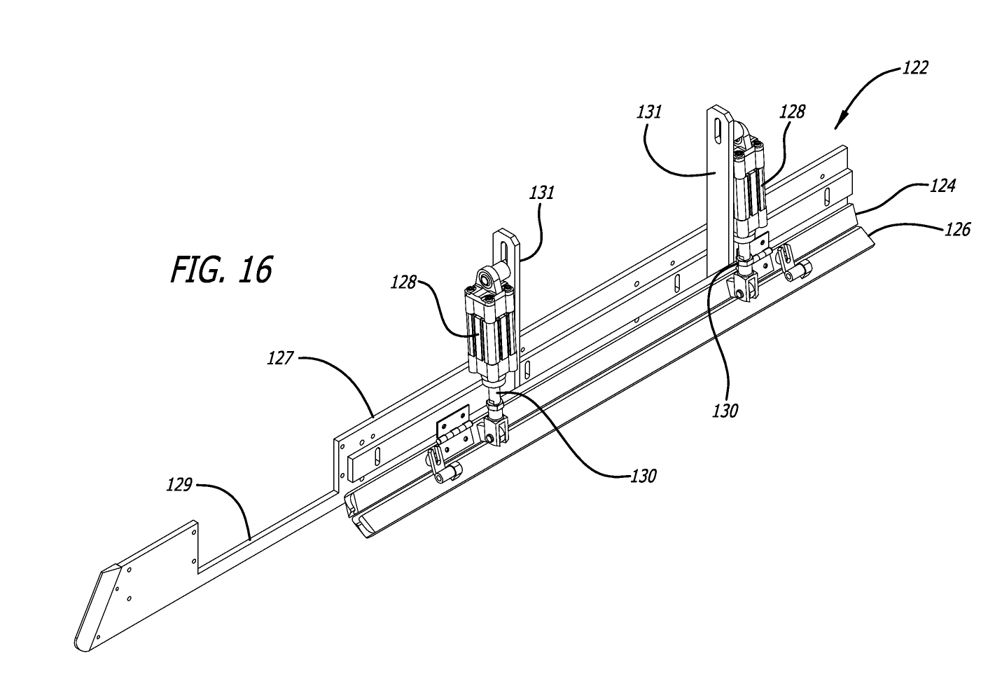

In the particular embodiment disclosed herein, another folding operation is performed in the first folding station 28 by a pair of lamination assemblies 122 each of which includes an upper lamination shoe 124 and a lower lamination shoe 126 designed to folds a particular portion of the box blank. The upper lamination shoe is attached to a lamination side plate 127 which acts lake an elongate mounting member for holding various components thereto. These lamination assemblies 122 are likewise disposed directly opposite from each other to allow the mechanisms to simultaneously fold both sides of the box blank. An air cylinder 128 is attached to linkages 130 which move these upper and lower lamination shoes 124 and 126 through their distinctive folding motion. Each air cylinder 128 used in the lamination assembly is attached to a mounting arm 131 which is also attached to the lamination side plate 127. As can be seen in FIGS. 15 and 16, the mounting plate 115 of the folding assembly 112 is also attached to the lamination side plate 127 at a location where a recess 129 is cut into the side plate 127. This provides an opening for the compression paddle 114 to extend in order to fold the box blank. Again it should be appreciated that in this particular embodiment, this first folding operation is directed to the folding of four panels 44 that are formed on the box blank and is just one of the many folding mechanisms that could be associated with this first folding station. The number of folds and type of folds which can be accomplished by this first folding station will depend upon the type of box to be folded by the box folding apparatus.

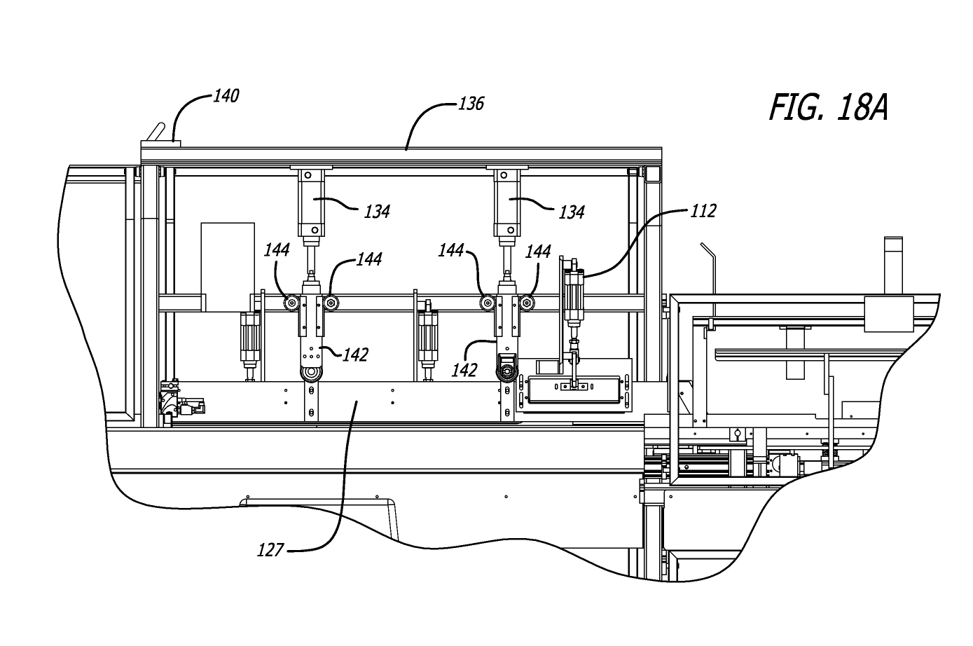

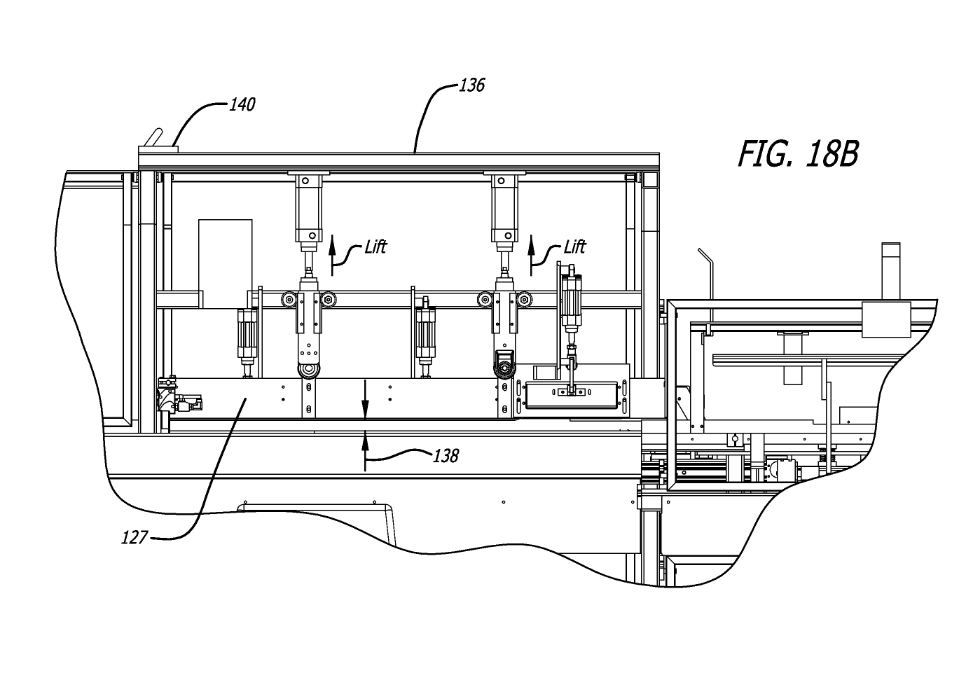

The folding assembly 112 and the lamination folding assembly 122 are both mounted to a movable support frame 132 to allow both assemblies 112 and 122 to be lifted from the box blank in the event of a jam up. This support frame 132 is, in turn, attached to a pair of air cylinders 134 that are attached to a portion of the main frame 136 forming the apparatus 20. These air cylinders 134 can be activated to lift support frame 132 and the folding mechanisms 122 from a box blank that may have become jammed therein during high speed production. FIG. 18A shows a side view of the folding mechanism 122 in contact with a box blank during normal operation. FIG. 18B shows the support frame 132 and mechanism 122 raised above the folding area. Arrows 138 show the amount of space that is created between parts when the support frame 132 has been lifted by the air cylinders 134. Thus, in the event that a box blank should become jammed within the folding mechanisms, the mechanisms can be simply lifted off the box blank a sufficient distance to allow the operator to easily and safely remove the jammed box blank from the first folding station. This lifting mechanism eliminates the need for the operator to cut and pull the jammed box blank from the folding mechanism, which can sometimes take considerable time to perform. A simple electrical switch 140 can be used to either raise or lower the support frame 132 and folding mechanism 112 and 122 as needed.

The support frame 132 includes a pair of stabilizing support assemblies 142 each of which ride along a pair of wheel guides 144 that are attached to the frame of the apparatus. Each side of the support frame include at least a pair of support assemblies 142. Wheel guides 144 are attached to a portion of the main frame. Each support assembly 142 rides between the pair of wheel guides 144 as the frame 132 is raised or lowered. This provides additional stability to the mechanism as it moves between raised and engaged positions.

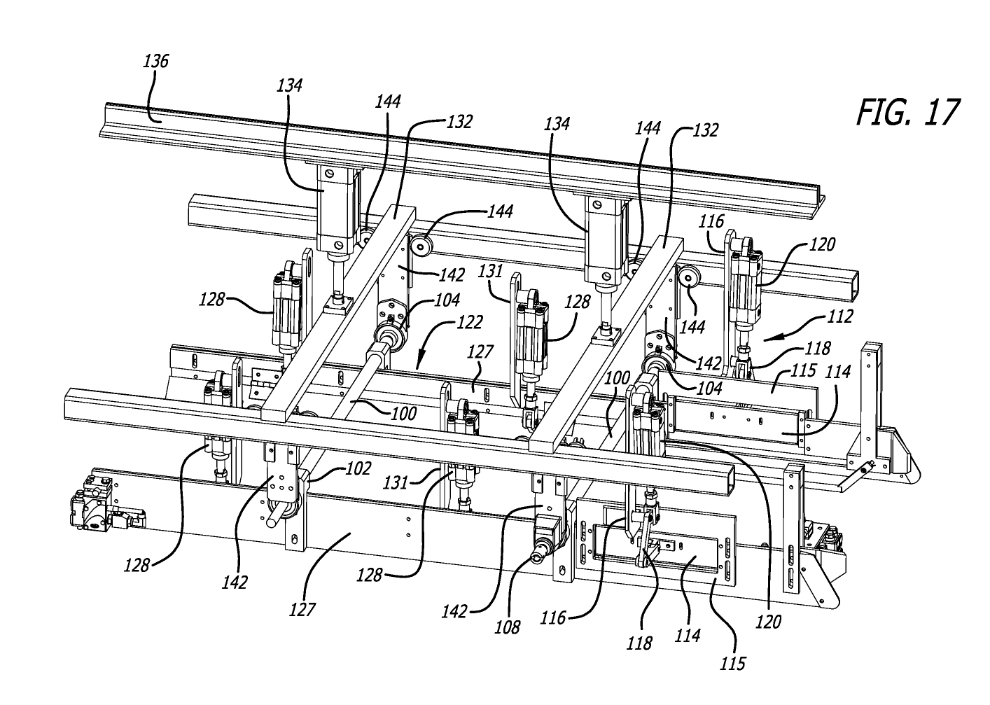

The support frame 132 may include a positioning mechanism which allow each folding assembly 112 and lamination assembly 122 to be moved laterally on the first folding station 28 to properly position the paddles 114 and upper and lower lamination shoes 124 and 126 relative to the sides of the box blank. For example, the lamination side plate 127 could be mounted on a mechanism similar to the one shown in FIG. 14C which utilizes sliding mounting assemblies which move along threaded rods 100 to position the assemblies 112 and 122 laterally at the first folding station 28. For example, as is shown in FIG. 17, each lamination side plate 127 can be attached to one or more a mounting assemblies 102 which move along the threaded rod 100 when the rod 100 is rotated. These threaded rods 100 can sit in bearings 104, like the ones shown in FIG. 14C, which are mounted on the inside surface of the support assembly 142. mounting. A crank coupling 108 can be attached to one of the rods 100 to allow the operator to rotate the rod 100 to laterally position the lamination side plate 127, and hence, the folding assembly 112 and lamination assembly 122 on the folding station 28. In this regard, sprockets and chains (not shown) like the ones described above with regard to FIG. 14C may be used to simultaneously rotate all of the threaded rods used in the positioning mechanism. In this manner, the folding mechanisms associated with the first folding station 28 can be both laterally positioned for different sized box blanks and can be lifted from a box blank which becomes jammed in the folding mechanism.

The specific folding mechanism used in the second folding station 30 is shown in greater detail in FIGS. 1, 3, 19A and 19B. As is mentioned above, this second folding station 30 receives the partially-folded box blank from the first folding station 28 and performs the final folding steps to create the finished box. After the folding mechanisms 112 and 122 associated in the first folding station 28 have finished the particular folding operations, the rear pusher assembly 68 engages the edge of the partially-folded blank and moves it from the first folding station 28 into the second folding station 30. Again, the movement of this partially-folded box blank is accomplished utilizing the same slider bar 62/actuating drive 50 which initially moves the unfolded box blank into the first folding station 28. The folding mechanisms associated with the second folding station 30 are again adapted to fold a particular box blank into the completed box.

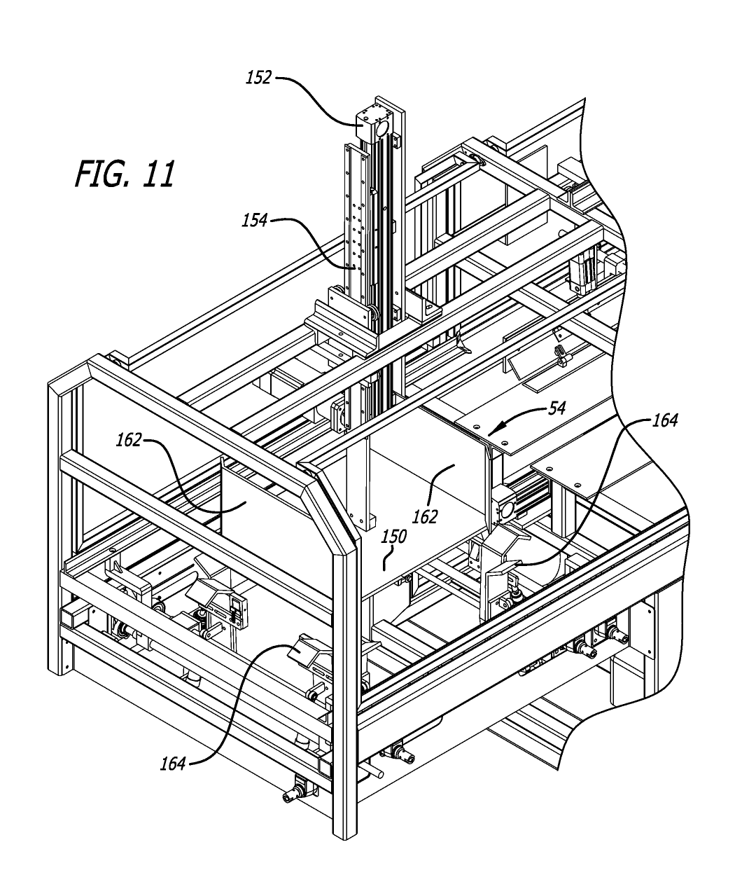

The folding mechanism of the second folding station 30 is feed by the actuating drive 52 which is specifically adapted to perform this function. In this regard, the actuating drive 52 includes a drive unit 152 which moves the forming mandrel 54 between upper and lower positions. FIGS. 1, 11 and 12 show the specific embodiment of the drive unit 152 and forming mandrel 54 used on the present embodiment. The drive unit 152 is very similar to the drive unit used to move the box blank from the feeding station 24 to the first folding station 28 and second folding station 30. A linear actuator 154 is attached to servo motor 156. During operation, the forming mandrel 54 remains in its upper position to allow a box blank to be position within the second feed position of the second folding station 30. Optical sensors can be used to provide a signal that the box blank has been properly placed in the second feed position ready to be feed into the folding mechanisms 160 which folds the blank into the finished box. In the particular mandrel assembly shown in FIGS. 1 and 11, the forming mandrel 54 has a pair of compression plates 162 used as an abutting component during the folding and compression steps. A bottom plate 150 of the mandrel 54 comes in direct contact with the partially-formed box blank in a position referred to the second feed position 158 since the box blank is now being fed into a new set of folding mechanisms. At this second feed position 158, the forming mandrel 54 starts its downward stroke coming in contact with the box blank and moving it into the opening of the folding mechanism 160 located directly beneath the folding mandrel 54. The moving of the box blank by the folding mandrel 54 causes side flaps/panels of the box blank to move upright forming the basic structure of the box. Compression is selectively applied by compression paddles (described in greater detail below) to bond the various portions of the box blank together to form the finished box. Thereafter, the forming mandrel 54 moves back to its original upper position to clear itself from the folding mechanism allowing the folding mechanisms 160 to fold the flaps/panels accordingly to create the competed box. The return stroke also places the forming mandrel 54 out of the path of the next incoming box blank which is immediately positioned in second feed position 158 of the second folding station 30. Again, as is described above, the return stroke of the actuating drive 52 can be done at a speed that is greater than the forward stroke since precise box blank alignment is not necessary.

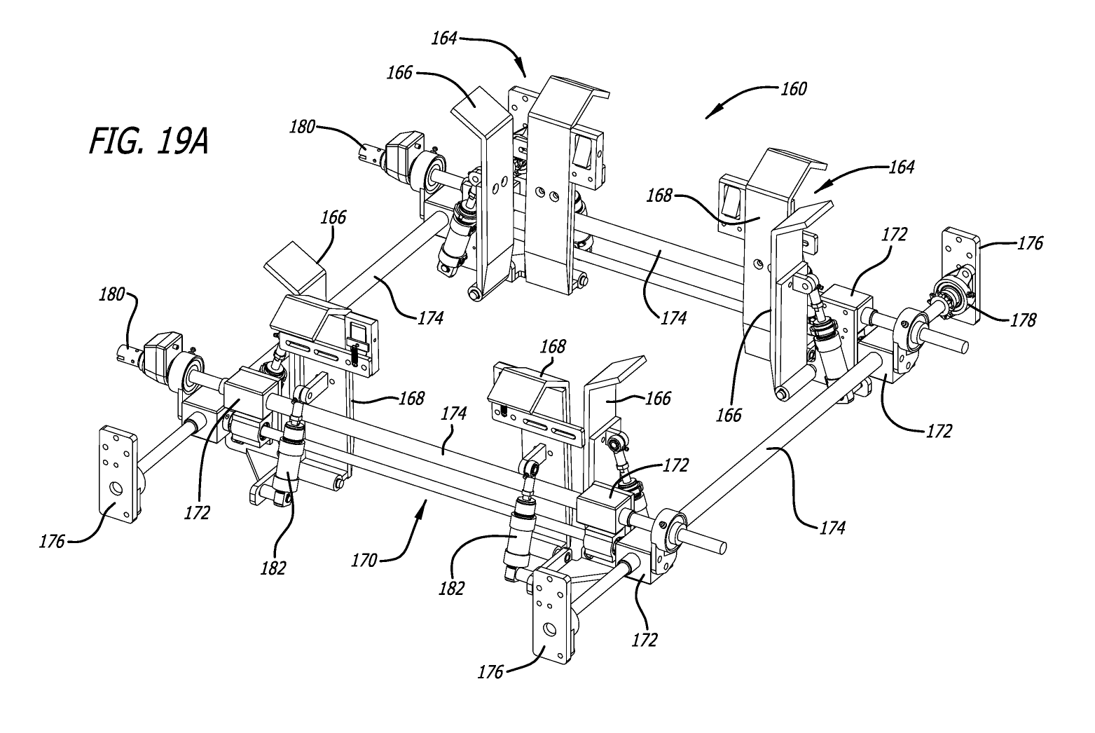

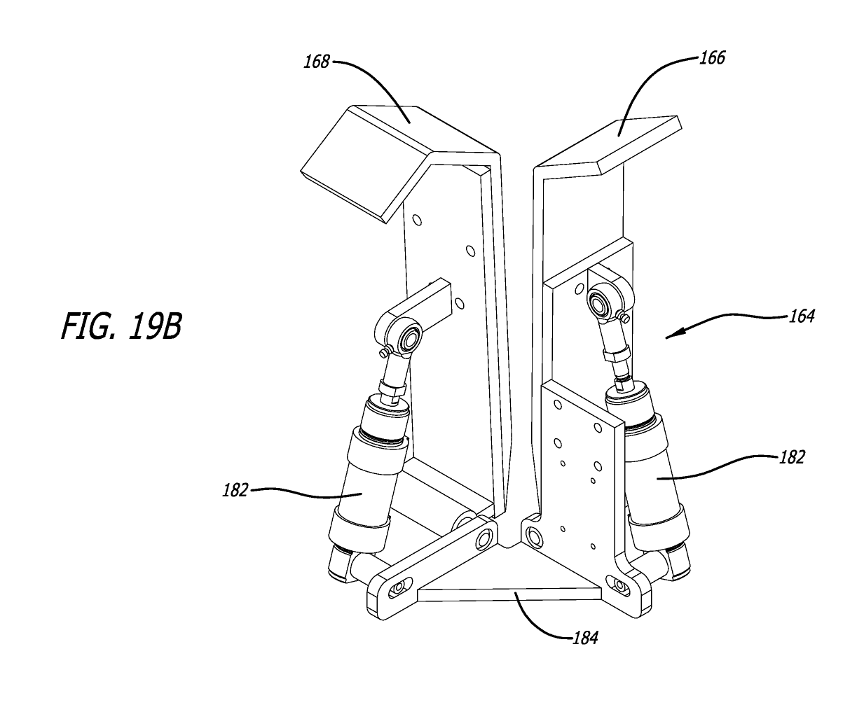

The folding mechanism 160 of the second folding station 30 is shown in greater detail in FIGS. 19A and 19B. The folding mechanism 160 includes four compression assemblies 164 which form the corners of the finished box. Each compression assembly 164 includes a side paddle 166 and an end paddle 168 which are movable between an open position, in which the box blank can be forced into the composite mechanism 160 by the forming mandrel 54. The paddles 166 and 168 can then be placed into a closed position in which the paddles move in contact with the box blank to compress portions of the box blank that are disposed between the paddle 168 and the compression plate 162 of the forming mandrel 54. In the particular folding steps of the box blank described herein, only the end paddles 168 actually apply a compressive force to the box blank since the portions of the box blank in contact with the side paddles 166 have already been permanently glued by the first folding station 28. The side paddles 166 can still move between the open and compressive positions to receive the box blank and hold it in place as the end paddles 168 apply compressive force to the box blank. Movement of the paddles 166 and 168 can be achieved by air cylinders associated with each compression assembly. After the compression cycle has finished, the folding mechanism 160 again opens allowing the completed box to drop where it can be advanced to another assembly line or location. During the time that the folding mechanism 160 is being actuated, another box blank can be advanced into the second folding station. The folding mechanism 160 is again open to receive another partially-folded blank that has been delivered from the first folding station 28. Once the completed box is released by the folding mechanism 160, the folding mandrel 54 is ready to make contact with the next box blank to move it into the folding mechanism 160.

FIG. 19A shows a particular positioning mechanism 170 which can be used to adjust the positions of the side and end paddles 166 and 168 of the folding mechanism 160. As can be seen in this figure, each of the compression assembly 164 is mounted on movable assemblies 172 mounted on threaded rods 174 that can be rotated to move the respective assemblies 172 and 162 along the lengths of each rod. This positioning assembly 170 includes mounting brackets 176 and bearings 178 used with the swing arm assembly 46 which allow the unit to be mounted to the main frame of the apparatus. A pair of crank coupling 180 can be attached to the threaded rods 174 to receive a hand crank 150 which allows the operator to rotate the rods accordingly. In this regard, the side and end paddles of each compression assembly 162 can be moved in two directions, as needed, via the travel along the threaded rods as the rods are rotated. Rotation of the rods 174 will translate into linear movement of the movable assemblies 172 and compressions assemblies 162 enabling the operator to move the paddles as may be needed for folding different sixed box blanks.

Each of the side and end paddles 166 and 168 are attached to an actuating mechanism, such as an air cylinder 182, which can be actuated accordingly to move the paddle between the open and compressed positions. In this regard, the air cylinder can vary the amount of force that can be applied when the paddle is moved to the compressive position. The paddles 166 and 168 can be mounted on a mounting assembly 184, shown in FIG. 19B.

The main frame of the box folding apparatus includes support columns and cross beams which provide the structure necessary to support the various folding and processing equipment. As can be seen in some of the figures, the main frame includes overhead rail supports used to mount the various glue assemblies and optical sensors. The main frame may include parallel rails 190 (see FIGS. 13A and 13C) that are used to support the box blanks during the folding operation. These rails 190 can extend, for example, from the feeding station to the second folding station. The edges of the box blank can ride on these rails through the folding process. As can be seen in FIG. 13C, a track 192 can be attached to this rail 190. Each front pusher assembly may include a set of wheels 194 which are adapted to ride in the track 192. The wheels 194 can be attached to a plate 196 which attached to the mounting assembly 78.

A glue supply (GS) is mounted on the main frame to supply glue via glue lines (not shown) to the various glue assemblies that are located at particular position on the main frame.

A box stop assembly can be mounted in the second folding station 30 to provide an abutting stop which allows the box blank to be properly positioned in the second feed position of the second folding station. A pair of box rebound stops could also be implemented to allow the box blank entering the second folding station from moving in a backward fashion once it has entered the second folding station.

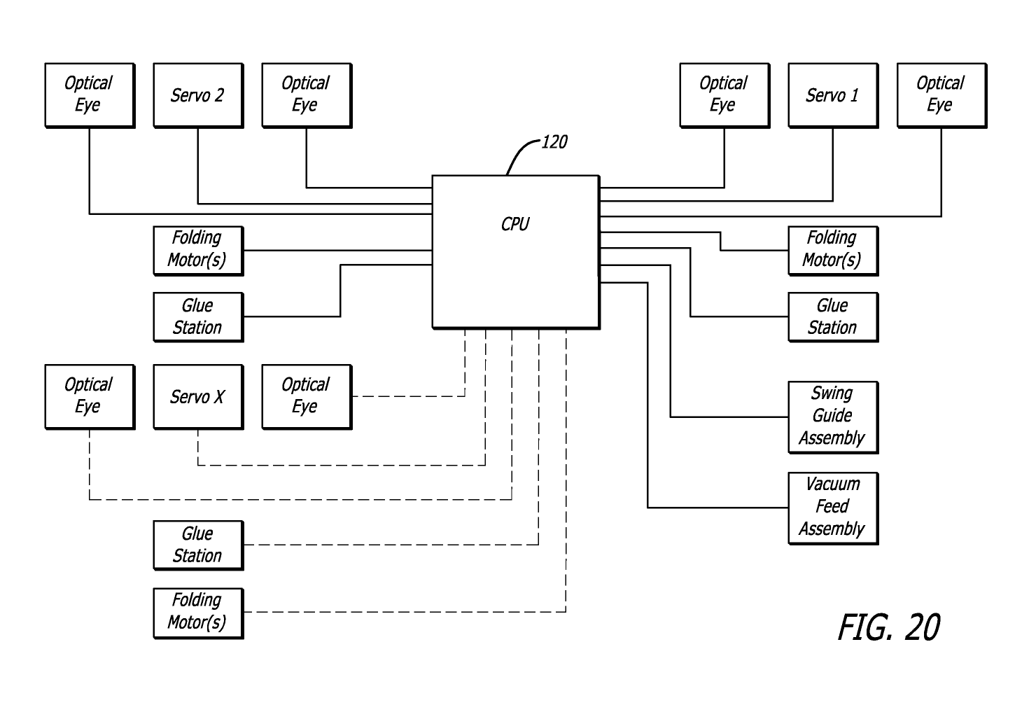

Referring now to FIG. 20, a schematic diagram which generally defines the controller 200 of the present invention is shown. The controller 200 of the apparatus is designated as a CPU which provides the control signals to the various mechanisms used in accordance with the present invention. In this regard, the controller 200 controls the first and second servos used with the actuating drives described herein. The controller also controls actuating drives and servo systems which could be implemented for additional advancement/folding equipment. The controller can provide the necessary signals to activate the motors and drives which activate the various folding mechanisms. The glue assemblies can be controlled by this controller as well. The movement of the vacuum assembly 34 and the swing guide assembly 46 can be controlled by the controller as well. Accordingly, the timing of these assemblies 34 and 46 relative to each other can be easily controlled.

Suitable servo-pneumatic systems which can be used with the present invention consist of a controller and a linear drive unit with a displacement encoder are manufactured by Festo Corporation, 395 Moreland Road, Hauppauge, N.Y. 11788. The various glue assemblies are commercially available. Pneumatic regulators, pneumatic lines, and generating sources are commercially available. Particular box blanks which can be folded by the disclosed embodiment are manufactured by International Paper and are described in U.S. patent Ser. No. 13/428,469 filed on Mar. 23, 2012 in the United States Patent and Trademark Office, whose entire contents are incorporated by reference. As is mentioned above, appropriate folding mechanisms can be used in place of the folding mechanisms described herein for different sized and shaped box blanks which could be folded in accordance with the apparatus and methods described herein.

While there have been described herein what are considered to be preferred and exemplary embodiments of the present invention, other modifications of the invention shall be apparent to those skilled in the art from the teachings herein and, it is therefore, desired to be secured in the appended claims all such modifications as fall within the true spirit and scope of the invention. Accordingly, what is desired to be secured by Letters Patent of the United States is the invention as defined and differentiated in the following claims.

We claim:

1. A box folding apparatus for folding a box blank, comprising:
a feeding station for receiving a box blank, the feeding station including:
a hopper assembly for holding a plurality of box blanks therein;
a feed assembly for engaging a box blank in the hopper assembly and moving the engaged box blank into a first feed position located on the feeding station; and
a swing guide assembly including a guide rail that is movable between an engaged position in which the guide rail contacts a portion of the box blank and a cleared position in which the guide rail is moved out of the first feed position.

2. The box folding apparatus of claim 1, wherein the swing guide assembly is synchronized with the feed assembly to move the guide rail into the engaged position once the box blank has been placed on the first feed position by the feed assembly.

3. The box folding apparatus of claim 2, wherein the feed assembly moves between a raised position to engage the box blank and a lower position in which the box blank is placed onto the first feed position and the swing guide assembly moves the guide rail out of the first feed position as the feed assembly moves to the raised position.

4. The box folding apparatus of claim 1, wherein the hopper assembly includes a pre-fold shoe which forces a portion of the box blank to extend away from the plane of the remaining portion of the box blank and the guide rail abuts against this extending portion of the box blank when the swing guide assembly is placed in the engaged position.

5. The box folding apparatus of claim 4, wherein the extending portion of the box blank is a preformed panel which is positioned in an upright position relative to the remaining portion of the box blank by the pre-fold shoe.

6. The box folding apparatus of claim 4, wherein the motion of the feed assembly going from the raised position to the lower position causes the box blank to abut the pre-fold shoe which forces the portion of the box blank to extend away from the plane of the remaining portion of the box blank.

7. The box folding apparatus of claim 1, further including:
an actuating drive controlled by a first servo system; and
a folding station including a folding mechanism for folding at least a portion of a box blank, wherein the actuating drive station moves the box blank from the first feed position into the folding station, the guide rail maintaining contact with the portion of the box blank as the box blank is moved into the folding station.

8. The box folding apparatus of claim 7, wherein the actuating drive has variable speed controlled by a servo system.

9. The box folding apparatus of claim 8, wherein the actuating drive has a forward linear stroke for moving the box blank from the first feed position into the folding station and a reverse linear stroke and the speed of the forward and rear linear strokes can be varied by the first servo system.

10. The box folding apparatus of claim 1, wherein the swing guide assembly includes a mechanism for moving the position that the guide rail assumes when in the engaged position.

11. A box folding apparatus for folding a box blank, comprising:
a feeding station for receiving a box blank; and
a folding station which receives a box blank from the feeding station, the folding station including a folding mechanism for at partially folding a portion of the box blank into a desired configuration, the box blank being movable along a contact surface of the folding station, the folding mechanism being movable from an engaged position in which the box blank is contacted and folded by the folding mechanism and a disengaged position in which the folding mechanism is raised a distance from the contact surface so that the folding mechanism does contact the box blank.

12. The box folding apparatus of claim 11, wherein the folding mechanism is mounted to a support frame and the support frame is attached to an actuating device which moves the folding mechanism between the engaged and disengaged positions.

13. The box folding apparatus of claim 11, further including:
an actuating drive controlled by a servo system, the actuating drive which moves the box blank from the feeding station into the folding station.

14. The box folding apparatus of claim 13, wherein the actuating drive has variable speed controlled by the servo system.

15. The box folding apparatus of claim 11, further including a positioning mechanism for changing the lateral position of the folding mechanism in the folding station.

16. The box folding apparatus of claim 12, further including a positioning mechanism mounted on the support frame for changing the lateral position of the folding mechanism on the support frame.

17. A box folding apparatus for folding a box blank, comprising:
a feeding station for receiving a box blank, the feeding station including:
a hopper assembly for holding a plurality of box blanks therein;
a feed assembly for engaging a box blank in the hopper assembly and moving the engaged box blank into a first feed position located on the feeding station; and
a swing guide assembly including a guide rail that is movable between an engaged position in which the guide rail contacts a portion of the box blank and a cleared position in which the guide rail is moved out of the first feed position; and
a folding station which receives a box blank from the feeding station, the folding station including a folding mechanism for at partially folding a portion of the box blank into a desired configuration, the box blank being movable along a contact surface of the folding station, the folding mechanism being movable from an engaged position in which the box blank is contacted and folded by the folding mechanism and a disengaged position in which the folding mechanism is raised a distance from the contact surface so that the folding mechanism does contact the box blank.

18. The box folding apparatus of claim 17, wherein the swing guide assembly is synchronized with the feed assembly to move the guide rail into the engaged position once the box blank has been placed on the first feed position by the feed assembly.

19. The box folding apparatus of claim 17, further including an actuating drive controlled by a first servo system which moves the box blank from the feeding station into the folding station.

20. A box folding apparatus for folding a box blank, comprising:
a feeding station including an actuating assembly associated with the feeding station, a hopper assembly for holding a stack of box blanks therein, a feed assembly associated with the hopper assembly for engaging a box blank in the hopper assembly and moving it to a first feed point, a swing guide assembly including a guide rail that is movable between an engaged position in which the guide rail contacts a portion of the box blank and a cleared position in which the guide rail is moved out of the first feed position;
a first folding station adjacent to the feeding station including a folding mechanism for folding a portion of a box blank, the first folding station including a folding mechanism for at partially folding a portion of the box blank into a desired configuration, the box blank being movable along a contact surface of the folding station, the folding mechanism being movable from an engaged position in which the box blank is contacted and folded by the folding mechanism and a disengaged position in which the folding mechanism is raised a distance from the contact surface so that the folding mechanism does contact the box blank;
a second folding station adjacent to the first folding station including a folding mechanism for folding a portion of the box blank; and
a first actuating assembly having an actuating drive controlled by a first servo system which produces a forward linear stroke which moves a box blank placed at the first feed position into the first folding station and simultaneously moves a box blank located in the first folding station into the second folding station.

21. The box folding apparatus of claim 20, wherein the actuating drive associated with the first actuating assembly can produce a variable actuating speed to move a box blank from the first feed position into the first folding station.

22. The box folding apparatus of claim 21, wherein the second folding station includes an actuating drive associated with the folding mechanism, the actuating drive associated with the folding mechanism being controlled by a second servo system operating independently from the first servo system, wherein the actuating drive associated with the folding mechanism can produce a variable actuating speed to move a box blank into the folding mechanism.

23. The box folding apparatus of claim 22, wherein the actuating drive associated with the folding mechanism drives a mandrel with a forward linear stroke which contacts and moves a box blank from a second feed position into the folding mechanism and a reverse linear stroke which moves the mandrel back to the second feed position.

24. The box folding apparatus of claim 23, wherein the folding mechanism of the second folding station includes a plurality of compression assemblies, each compression assembly including a movable end paddle and a movable side paddle, each of the end and side paddles being independently movable between a engaged position and non-compressing position, each compression assembly being mounted on a mechanism which positions each compression assembly relative to another compression assembly, wherein the end and side paddles produce a compressive force on a portion of a box blank which extends between the respective paddle and the forming mandrel when the paddle is in the engaged position.

25. A method for folding a box blank into a box, comprising:
placing a box blank on a first feed position of a feeding station;
moving a guide rail of a swing guide assembly into an engaged position in which the guide rail contacts a portion of the box blank;
advancing the box blank from the feeding station into a first folding station while the guide rail remains in contact with a portion of the box blank;
moving the guide rail into a cleared position away from the first feed position; and
placing another box blank on the first feed position after the guide rail has moved into the cleared position.

26. The method of claim 25, wherein the advancement of the box blank from the feeding station into the first folding station is performed by a first actuating drive controlled by a first servo system.

27. The method of claim 25, further including:
returning the first actuating drive to the first feed point to engage another box blank.

28. The method of claim 25, wherein the box blank placed on the first feeding position has been pre-folded to allow at least one panel to be placed in an upright position, the guide rail being in contact with this one or more upright panel when placed in the engaged position.
